(19) United States
(12) Patent Application Publication
(10) Pub. No.: US 2024/0094599 A1
(43) Pub. Date: Mar. 21, 2024

(54) OPTICAL IMAGE STABILIZATION WITH ASYMMETRIC STROKE FOR CAMERA DEVICES

(71) Applicant: Meta Platforms Technologies, LLC, Menlo Park, CA (US)

(72) Inventors: Abhishek Dhanda, San Ramon, CA (US); Lidu Huang, Danville, CA (US); Honghong Peng, Los Altos, CA (US)

(21) Appl. No.: 18/099,868

(22) Filed: Jan. 20, 2023

Related U.S. Application Data
(60) Provisional application No. 63/308,429, filed on Feb. 9, 2022.
(60) Provisional application No. 63/345,347, filed on May 24, 2022.

(51) Int. Cl. G03B 5/00; G02B 27/64; G04G 21/02; H04N 23/55; H04N 23/57; H04N 23/68

(52) U.S. Cl. CPC G03B 5/00; G02B 27/646; G04G 21/02; H04N 23/55; H04N 23/57; H04N 23/681; H04N 23/687; G03B 30/00

(57) ABSTRACT

Embodiments of the present disclosure relate to a camera device with optical image stabilization (OIS) having a range of motion that is asymmetric along two spatial dimensions. The camera device includes an image sensor, a lens assembly in an optical series with the image sensor, and an OIS assembly. The OIS assembly initiates a first motion of at least one of the image sensor and the lens assembly along a first direction parallel to a first axis, the first motion having a first range. The OIS assembly further initiates a second motion of at least one of the image sensor and the lens assembly along a second direction parallel to a second axis orthogonal to the first axis, the second motion having a second range different than the first range.

### CROSS REFERENCE TO RELATED APPLICATIONS

This application claims a priority and benefit to U.S. Provisional Patent Application Ser. No. 63/308,429, filed Feb. 9, 2022, and to U.S. Provisional Patent Application Ser. No. 63/345,347, filed May 24, 2022, each of which is hereby incorporated by reference in its entirety.

### FIELD OF THE INVENTION

The present disclosure relates generally to camera devices, and specifically relates to optical image stabilization with asymmetric stroke for camera devices.

### BACKGROUND

Optical image stabilization applied at a camera device requires tradeoff between power consumption and performance of the camera device. Better performance of the camera device requires a longer stroke. However, with a longer stoke, power usage at the camera device may increase. Additionally, module size(s) (i.e., footprint) in relation to optical image stabilization component(s) of the camera device may also increase with a longer stroke. Letting lens of the camera device fully sag due to gravity (e.g., at the horizontal posture of the camera device) can save power but may not leave enough stroke, which can negatively affect performance of the camera device especially for longer exposures of the camera device.

Typically, a camera lens is first installed into a lens barrel, and then an optical axis of the camera lens is aligned in a passive manner, where the alignment is determined by a dimension and tolerance control of the lens barrel and the camera lens. Active optical alignment is commonly applied if there are multiple lenses to be installed into a lens barrel. Additionally, some type of lenses can be embedded into or integrated with the lens barrel by the use of an actuator. However, the lens performance can be different when the actuator is turned on and turned off. For example, a tunable lens is flat when the tunable lens is powered off (i.e., when the tunable lens is in idle state), and an optical axis of the tunable lens cannot be aligned at the powered-off state. Thus, the alignment of tunable lens into the lens barrel requires activation of the tunable lens, which further requires an external power supply unit (e.g., different from a driver of a camera device) and temporal electrical connections (e.g., wire bonding). In some cases, a design of the lens barrel design can be modified to facilitate alignment of the lens and lens assembly. All of these make the lens installation and alignment process more complex.

A lens barrel is a critical component of compact camera device as multiple lenses can be installed into the lens barrel. Electrical contacts can be integrated into the lens barrel for actuators (e.g., voice coil motors), tunable lenses, an optical image stabilization (OIS) actuator, sensors, etc. Metal insert molding is widely used to enable electrical wiring and electrical contact inside a body of the lens barrel. A metal insert represents a very thin sheet or wire embedded into the body of the lens barrel. The critical dimension of the metal insert can be, e.g., less than 0.1 mm, and the metal insert can be very flexible. The body of the lens barrel provides enough mechanical support to the metal insert to prevent the metal insert from moving or deforming. When the metal insert is embedded into the lens barrel, the large mismatch of coefficients of thermal expansion (CTE) of the metal insert, lens barrel and electrical contacts can result in large thermal stress at electrical contacts, thus raising reliability concerns. A large thermal mechanical stress at electrical contacts can bring risks to an actuator or a sensor, since the actuator and the sensor are both sensitive to the thermal mechanical stress. A thermal mechanical stress on an electrical (metal) contact can be as high as, e.g., 100 MPa, and can lead to a large deformation of the electrical contact.

### SUMMARY

Embodiments of the present disclosure relate to a camera device (e.g., wearable camera device) with optical image stabilization (OIS) having a range of motion that is asymmetric along two spatial dimensions. The camera device includes an image sensor, a lens assembly in an optical series with the image sensor, and an OIS assembly. The OIS assembly initiates a first motion of at least one of the image sensor and the lens assembly along a first direction parallel to a first axis, the first motion having a first range. The OIS assembly further initiates a second motion of at least one of the image sensor and the lens assembly along a second direction parallel to a second axis orthogonal to the first axis, the second motion having a second range different than the first range. In some embodiments, the lens assembly and the image sensor allow the first motion along the first direction parallel to the first axis to have the first range, and the second motion along the second direction parallel to the second axis to have the second range different from the first range.

The camera device presented herein may be part of a wristband system, e.g., a smartwatch or some other electronic wearable device. Additionally or alternatively, the camera device may be part of a handheld electronic device (e.g., smartphone) or some other portable electronic device.

### BRIEF DESCRIPTION OF THE DRAWINGS

FIG. 1A is a top view of an example wristband system, in accordance with one or more embodiments.

FIG. 1B is a side view of the example wristband system of FIG. 1A.

FIG. 2A is a perspective view of another example wristband system, in accordance with one or more embodiments.

FIG. 2B is a perspective view of the example wristband system of FIG. 2A with a watch body released from a watch band, in accordance with one or more embodiments.

FIG. 3 is a cross section of an electronic wearable device, in accordance with one or more embodiments.

FIG. 4A is a cross section of a camera device in an upward (vertical) posture, in accordance with one or more embodiments.

FIG. 4B is a cross section of a camera device in a forward (horizontal) posture, in accordance with one or more embodiments.

FIG. 5 illustrates an example movement of an electronic wearable device along two spatial dimensions, in accordance with one or more embodiments.

FIG. 6A illustrates an example OIS assembly of a camera device with a symmetric stroke map, in accordance with one or more embodiments.

FIG. 6B illustrates an example OIS assembly of a camera device with an asymmetric stroke map, in accordance with one or more embodiments.

FIG. 7A illustrates an example motion profile of an actuator of a camera device, in accordance with one or more embodiments.

FIG. 7B illustrates an example stroke map of a camera device for compensating a larger motion of the camera device in one direction, in accordance with one or more embodiments.

FIG. 8 is a flowchart illustrating a process of initiating an asymmetric stroke at a camera device for OIS, in accordance with one or more embodiments.

FIG. 9A illustrates an example lens reference alignment system, in accordance with one or more embodiments.

FIG. 9B illustrates an example lens pick up head of the lens reference alignment system of FIG. 9A, in accordance with one or more embodiments.

FIG. 9C illustrates an example optical imaging system of the lens reference alignment system of FIG. 9A, in accordance with one or more embodiments.

FIG. 10A illustrates an example alignment of a lens reference alignment system, in accordance with one or more embodiments.

FIG. 10B illustrates an example process of a lens reference optical alignment, in accordance with one or more embodiments.

FIG. 10C illustrates an example final state after the lens reference optical alignment and lens pick up, in accordance with one or more embodiments.

FIG. 11A illustrates an example of installation of a lens assembly into a lens barrel, in accordance with one or more embodiments.

FIG. 11B illustrates an example process of installation of a lens assembly into a lens barrel, in accordance with one or more embodiments.

FIG. 12 illustrates an example lens barrel with a floating metal insert, in accordance with one or more embodiments.

FIG. 13 illustrates an example lens barrel with an L-shape metal insert, in accordance with one or more embodiments.

FIG. 14 illustrates an example process of forming a floating metal insert for the lens barrel of FIG. 12, in accordance with one or more embodiments.

FIG. 15 illustrates an example process of forming an L-shape metal insert for the lens barrel of FIG. 13, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Embodiments of the present disclosure relate to a camera device (e.g., wearable camera device) with an OIS assembly and an autofocus assembly. The OIS assembly may initiate a range of motion that is asymmetric (e.g., different along a first direction than along a second direction orthogonal to the first direction). The asymmetry is such that the range of motion in a direction where more motion of the camera device is expected (e.g., vertical direction) is longer than in the orthogonal direction (e.g., horizontal direction). This approach can provide better tradeoff between a size of the OIS assembly and performance of the camera device. One or more components of the OIS assembly may have a smaller footprint, improved dynamics of the camera device can be achieved, as well as a reduced power consumption at the camera device.

The camera device may be incorporated into a small form factor electronic device, such as an electronic wearable device. Examples of electronic wearable devices include a smartwatch or a head-mount display (HMD). The electronic device can include other components (e.g., haptic devices, speakers, etc.). And, the small form factor of the electronic device provides limited space between the other components and the camera device. In some embodiments, the electronic device may have limited power supply (e.g., due to being dependent on a re-chargeable battery).

In some embodiments, the electronic wearable device may operate in an artificial reality environment (e.g., a virtual reality environment). The camera device of the electronic wearable device may be used to enhance an artificial reality application running on an artificial reality system (e.g., running on an HMD device worn by the user). The camera device may be disposed on multiple surfaces of the electronic wearable device such that data from a local area, e.g., surrounding a wrist of the user, may be captured in multiple directions. For example, one or more images may be captured describing the local area and the images may be sent and processed by the HMD device prior to be presented to the user.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including an electronic wearable device (e.g., headset) connected to a host computer system, a standalone electronic wearable device (e.g., headset, smartwatch, bracelet, etc.), a mobile device or computing system, or any other hardware platform capable of providing artificial reality content to one or more viewers.

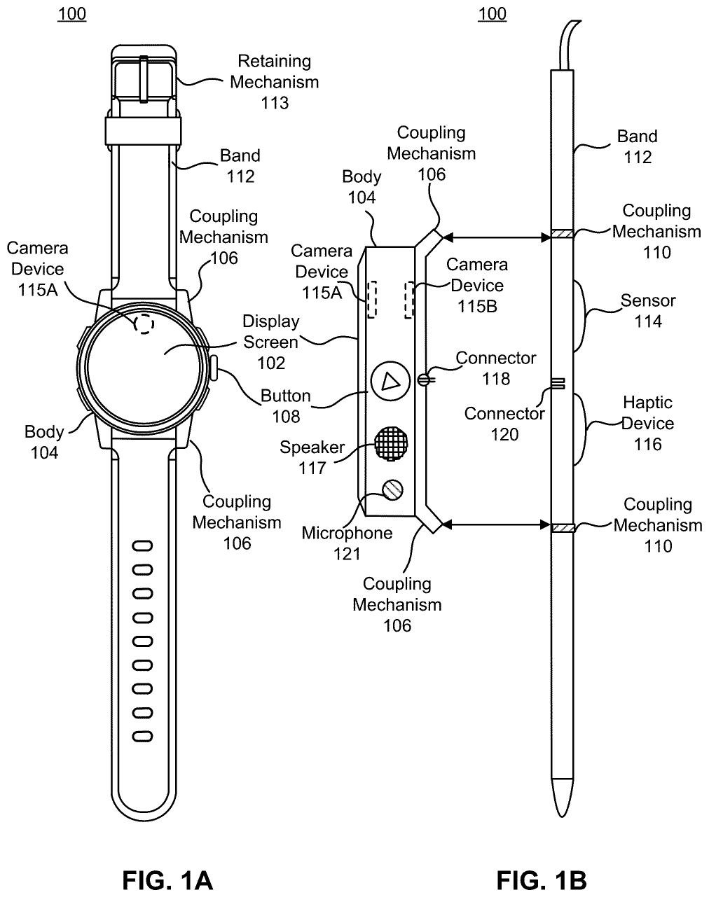

FIG. 1A is a top view of an example wristband system 100, in accordance with one or more embodiments. FIG. 1B is a side view of the example wristband system 100 of FIG. 1A. The wristband system 100 is an electronic wearable device and may be worn on a wrist or an arm of a user. In some embodiments, the wristband system 100 is a smartwatch. Media content may be presented to the user wearing the wristband system 100 using a display screen 102 and/or one or more speakers 117. However, the wristband system 100 may also be used such that media content is presented to a user in a different manner (e.g., via touch utilizing a haptic device 116). Examples of media content presented by the wristband system 100 include one or more images, video, audio, or some combination thereof. The wristband system 100 may operate in an artificial reality environment (e.g., a VR environment, an AR environment, a MR environment, or some combination thereof).

In some examples, the wristband system 100 may include multiple electronic devices (not shown) including, without limitation, a smartphone, a server, a head-mounted display (HMD), a laptop computer, a desktop computer, a gaming system, Internet of things devices, etc. Such electronic devices may communicate with the wristband system 100 (e.g., via a personal area network). The wristband system 100 may have sufficient processing capabilities (e.g., central processing unit (CPU), memory, bandwidth, battery power, etc.) to offload computing tasks from each of the multiple electronic devices to the wristband system 100. Additionally, or alternatively, each of the multiple electronic devices may have sufficient processing capabilities (e.g., CPU, memory, bandwidth, battery power, etc.) to offload computing tasks from the wristband system 100 to the electronic device(s).

The wristband system 100 includes a watch body 104 coupled to a watch band 112 via one or more coupling mechanisms 106, 110. The watch body 104 may include, among other components, one or more coupling mechanisms 106, one or more camera devices 115 (e.g., camera device 115A and 115B), the display screen 102, a button 108, a connector 118, a speaker 117, and a microphone 121. The watch band 112 may include, among other components, one or more coupling mechanisms 110, a retaining mechanism 113, one or more sensors 114, the haptic device 116, and a connector 120. While FIGS. 1A and 1B illustrate the components of the wristband system 100 in example locations on the wristband system 100, the components may be located elsewhere on the wristband system 100, on a peripheral electronic device paired with the wristband system 100, or some combination thereof. Similarly, there may be more or fewer components on the wristband system 100 than what is shown in FIGS. 1A and 1B. For example, in some embodiments, the watch body 104 may include a port for connecting the wristband system 100 to a peripheral electronic device and/or to a power source. The port may enable charging of a battery of the wristband system 100 and/or communication between the wristband system 100 and a peripheral device. In another example, the watch body 104 may include an inertial measurement unit (IMU) that measures a change in position, an orientation, and/or an acceleration of the wristband system 100. The IMU may include one or more sensors, such as one or more accelerometers, one or more gyroscopes, one or more magnetometers, another suitable type of sensor that detects motion, a type of sensor used for error correction of the IMU, or some combination thereof.

The watch body 104 and the watch band 112 may have any size and/or shape that is configured to allow a user to wear the wristband system 100 on a body part (e.g., a wrist). The wristband system 100 may include the retaining mechanism 113 (e.g., a buckle) for securing the watch band 112 to the wrist of the user. The coupling mechanism 106 of the watch body 104 and the coupling mechanism 110 of the watch band 112 may attach the watch body 104 to the watch band 112. For example, the coupling mechanism 106 may couple with the coupling mechanism 110 by sticking to, attaching to, fastening to, affixing to, some other suitable means for coupling to, or some combination thereof.

The wristband system 100 may perform various functions associated with the user. The functions may be executed independently in the watch body 104, independently in the watch band 112, and/or in communication between the watch body 104 and the watch band 112. In some embodiments, a user may select a function by interacting with the button 108 (e.g., by pushing, turning, etc.). In some embodiments, a user may select a function by interacting with the display screen 102. For example, the display screen 102 is a touchscreen and the user may select a particular function by touching the display screen 102. The functions executed by the wristband system 100 may include, without limitation, displaying visual content to the user (e.g., displaying visual content on the display screen 102), presenting audio content to the user (e.g., presenting audio content via the speaker 117), sensing user input (e.g., sensing a touch of button 108, sensing biometric data with the one or more sensors 114, sensing neuromuscular signals with the one or more sensors 114, etc.), capturing audio content (e.g., capturing audio with microphone 121), capturing data describing a local area (e.g., with a front-facing camera device 115A and/or a rear-facing camera device 115B), communicating wirelessly (e.g., via cellular, near field, Wi-Fi, personal area network, etc.), communicating via wire (e.g., via the port), determining location (e.g., sensing position data with a sensor 114), determining a change in position (e.g., sensing change(s) in position with an IMU), determining an orientation and/or acceleration (e.g., sensing orientation and/or acceleration data with an IMU), providing haptic feedback (e.g., with the haptic device 116), etc.

The display screen 102 may display visual content to the user. The displayed visual content may be oriented to the eye gaze of the user such that the content is easily viewed by the user. Traditional displays on wristband systems may orient the visual content in a static manner such that when a user moves or rotates the wristband system, the content may remain in the same position relative to the wristband system causing difficulty for the user to view the content. The displayed visual content may be oriented (e.g., rotated, flipped, stretched, etc.) such that the displayed content remains in substantially the same orientation relative to the eye gaze of the user (e.g., the direction in which the user is looking). The displayed visual content may also be modified based on the eye gaze of the user. For example, in order to reduce the power consumption of the wristband system 100, the display screen 102 may dim the brightness of the displayed visual content, pause the displaying of visual content, or power down the display screen 102 when it is determined that the user is not looking at the display screen 102. In some examples, one or more sensors 114 of the wristband system 100 may determine an orientation of the display screen 102 relative to an eye gaze direction of the user.

The position, orientation, and/or motion of eyes of the user may be measured in a variety of ways, including through the use of optical-based eye-tracking techniques, infrared-based eye-tracking techniques, etc. For example, the front-facing camera device 115A and/or rear-facing camera device 115B may capture data (e.g., visible light, infrared light, etc.) of the local area surrounding the wristband system 100 including the eyes of the user. The captured data may be processed by a controller (not shown) internal to the wristband system 100, a controller external to and in communication with the wristband system 100 (e.g., a controller of an HMD), or a combination thereof to determine the eye gaze direction of the user. The display screen 102 may receive the determined eye gaze direction and orient the displayed content based on the eye gaze direction of the user.

In some embodiments, the watch body 104 may be communicatively coupled to an HMD. The front-facing camera device 115A and/or the rear-facing camera device 115B may capture data describing the local area, such as one or more wide-angle images of the local area surrounding the front-facing camera device 115A and/or the rear-facing camera device 115B. The wide-angle images may include hemispherical images (e.g., at least hemispherical, substantially spherical, etc.), 180-degree images, 360-degree area images, panoramic images, ultra-wide area images, or a combination thereof. In some examples, the front-facing camera device 115A and/or the rear-facing camera device 115B may be configured to capture images having a range between 45 degrees and 360 degrees. The captured data may be communicated to the HMD and displayed to the user on a display screen of the HMD worn by the user. In some examples, the captured data may be displayed to the user in conjunction with an artificial reality application. In some embodiments, images captured by the front-facing camera device 115A and/or the rear-facing camera device 115B may be processed before being displayed on the HMD. For example, certain features and/or objects (e.g., people, faces, devices, backgrounds, etc.) of the captured data may be subtracted, added, and/or enhanced before displaying on the HMD.

Components of the front-facing camera device 115A and the rear-facing camera device 115B may be capable of taking pictures capturing data describing the local area. A lens of the front-facing camera device 115A and/or a lens of the rear-facing camera device 115B can be automatically positioned at their target positions. A target position in a forward (or horizontal) posture of the front-facing camera device 115A may correspond to a position at which the lens of the front-facing camera device 115A is focused at a preferred focal distance (e.g., distance in the order of several decimeters). A target position in a forward (or horizontal) posture of the rear-facing camera device 115B may correspond to a position at which the lens of the rear-facing camera device 115B is focused at a hyperfocal distance in the local area (e.g., a distance of approximately 1.7 meter). An upward (vertical) posture of the front-facing camera device 115A (or the rear-facing camera device 115B) corresponds to a posture where an optical axis is substantially parallel to gravity. And a forward (horizontal) posture of the front-facing camera device 115A (or the rear-facing camera device 115B) corresponds to a posture when the optical axis is substantially orthogonal to gravity.

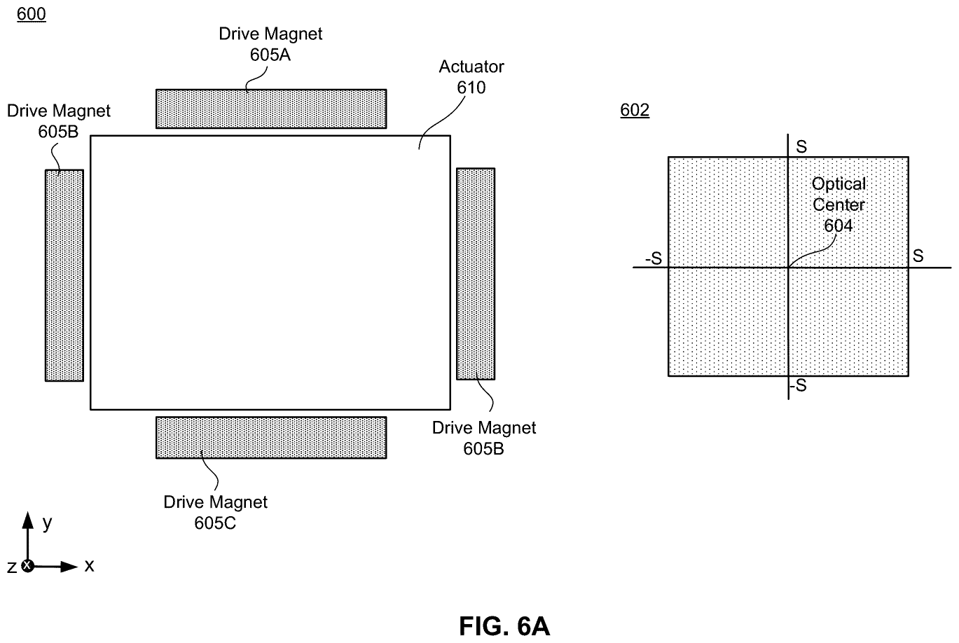

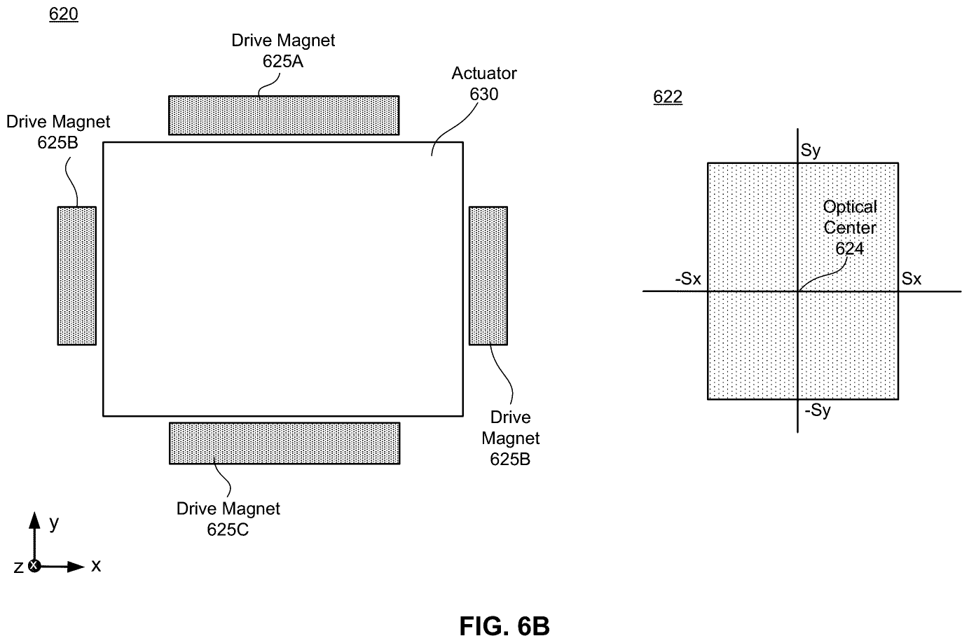

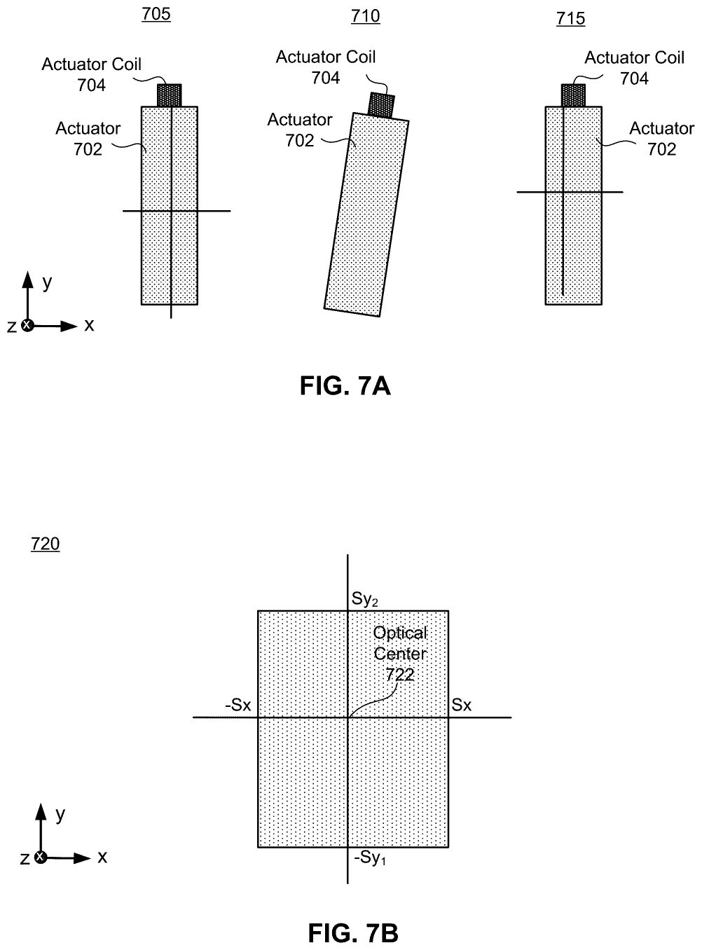

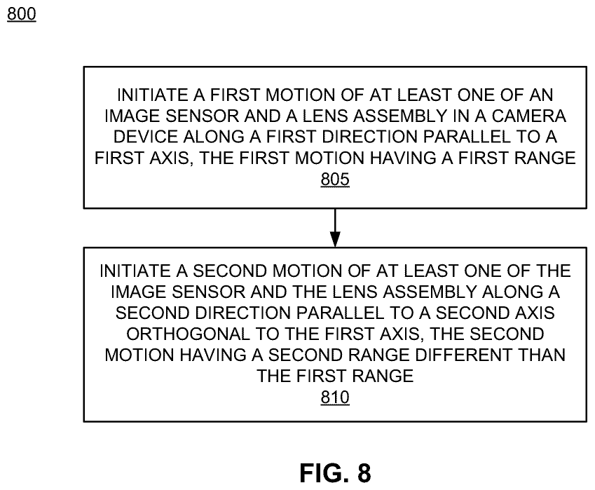

When the front-facing camera device 115A (and the rear-facing camera device 115B) changes its posture from, e.g., an upward posture to a forward posture, OIS may be applied by allowing a certain amount of shift (i.e., stroke) of a lens and/or image sensor of the front-facing camera device 115A (and the rear-facing camera device 115B) along at least one spatial direction. Stroke ranges may be asymmetric, i.e., an amount of shift along a first direction may be different than an amount of shift along a second direction orthogonal to the first direction. For example, a shifting range in a direction where more motion of the front-facing camera device 115A (and the rear-facing camera device 115B) is expected (e.g., vertical direction) is longer than in the orthogonal direction (e.g., horizontal direction). Details about mechanisms for achieving asymmetric strokes for the orthogonal directions are provided below in relation to FIG. 6B, FIGS. 7A-7B and FIG. 8.

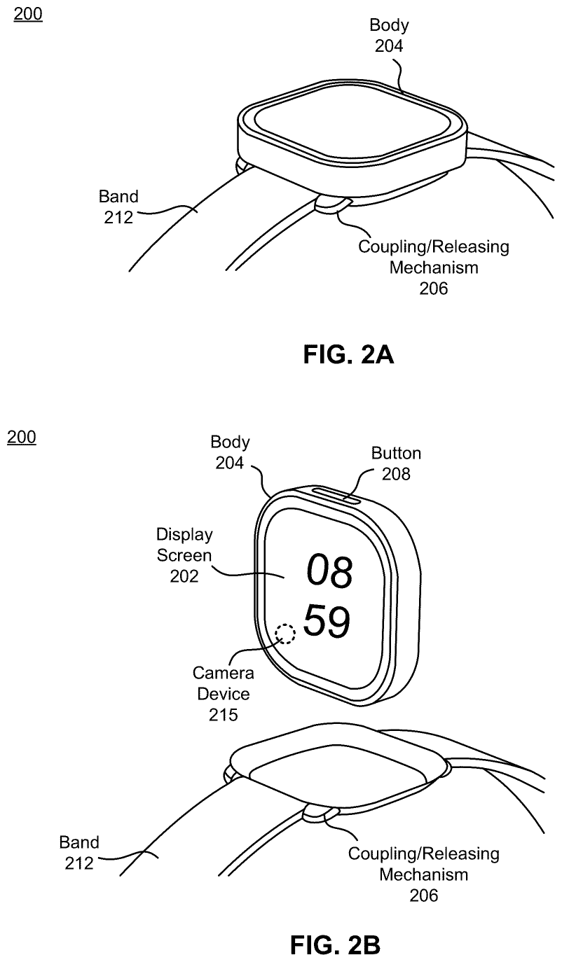

FIG. 2A is a perspective view of another example wristband system 200, in accordance with one or more embodiments. The wristband system 200 includes many of the same components described above with reference to FIGS. 1A and 1B, but a design or layout of the components may be modified to integrate with a different form factor. For example, the wristband system 200 includes a watch body 204 and a watch band 212 of different shapes and with different layouts of components compared to the watch body 104 and the watch band 112 of the wristband system 100. FIG. 2A further illustrates a coupling/releasing mechanism 206 for coupling/releasing the watch body 204 to/from the watch band 212.

FIG. 2B is a perspective view of the example wristband system 200 with the watch body 204 released from the watch band 212, in accordance with one or more embodiments. FIG. 2B further illustrates a camera device 215A, a display screen 202, and a button 208. In some embodiments, another camera device may be located on an underside of the watch body 204 and is not shown in FIG. 2B. In some embodiments (not shown in FIGS. 2A-2B), one or more sensors, a speaker, a microphone, a haptic device, a retaining mechanism, etc. may be included on the watch body 204 or the watch band 212. As the wristband system 100 and the wristband system 200 are of a small form factor to be easily and comfortably worn on a wrist of a user, the corresponding camera devices 115, 215 and various other components of the wristband system 100 and the wristband system 200 described above are designed to be of an even smaller form factor and are positioned close to each other.

When the camera device 215 changes its posture, e.g., from an upward posture to a forward posture, OIS may be applied by allowing a certain amount of shift (i.e., stroke) of a lens and/or image sensor of the camera device 215 along at least one spatial direction. Ranges of strokes may be asymmetric for the orthogonal spatial directions, i.e., an amount of shift along a first direction may be different than an amount of shift along a second direction orthogonal to the first direction. For example, a shifting range in a direction where more motion of the camera device 215 is expected (e.g., vertical direction) may be longer than a shifting range in the orthogonal direction (e.g., horizontal direction). Details about mechanisms for achieving asymmetric strokes for the orthogonal directions at the camera device 215 are provided below in relation to FIG. 6B, FIGS. 7A-7B and FIG. 8.

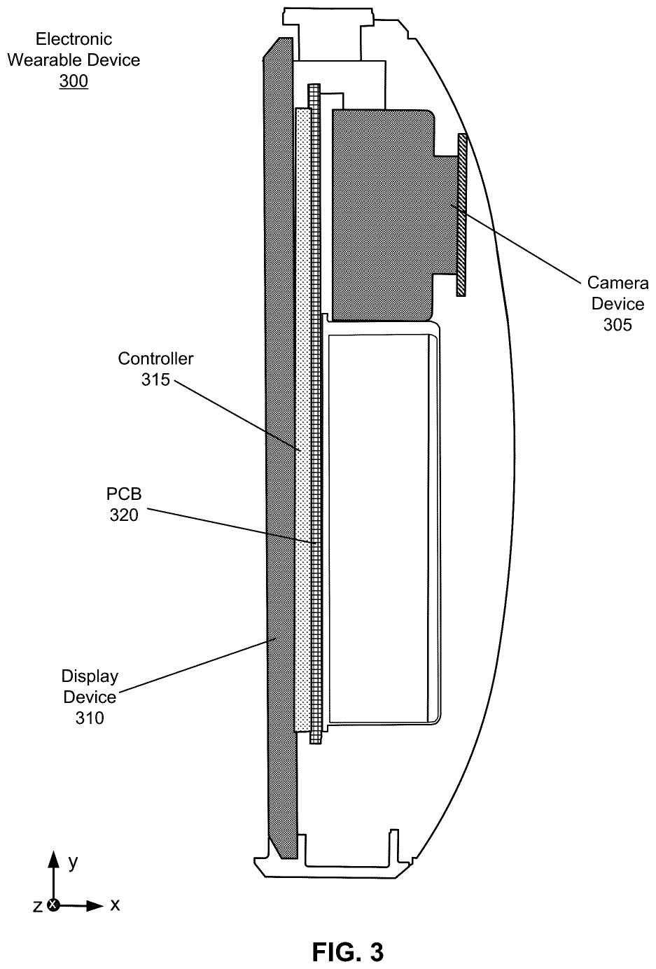

FIG. 3 is a cross section of an electronic wearable device 300, in accordance with one or more embodiments. The electronic wearable device 300 may be worn on a wrist or an arm of a user. In some embodiments, the electronic wearable device 300 is a smartwatch. The electronic wearable device 300 may be an embodiment of the wristband system 100 or the wristband system 200. The electronic wearable device 300 is shown in FIG. 3 in the forward (horizontal) posture. The electronic wearable device 300 includes a camera device 305, a display device 310, a controller 315, and a printed circuit board (PCB) 320. There may be more or fewer components of the electronic wearable device 300 than what is shown in FIG. 3.

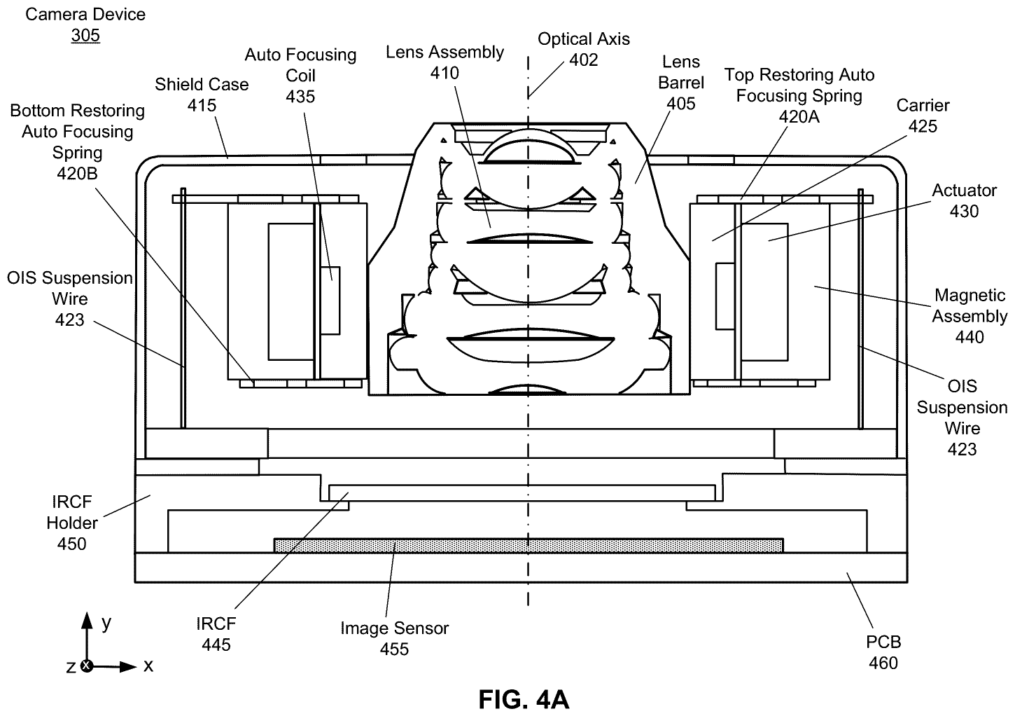

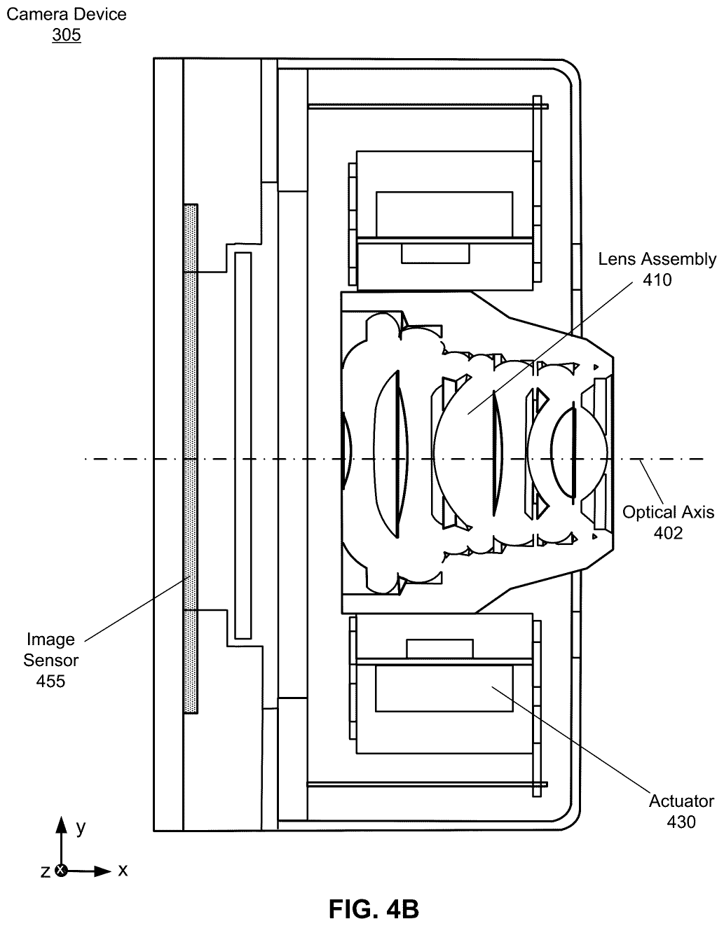

The camera device 305 may capture data (e.g., one or more images) of a local area surrounding the electronic wearable device 300. The camera device 305 may be an embodiment of the camera devices 115, 215. Details about a structure and operation of the camera device 305 are provided below in relation to FIGS. 4A and 4B.

The display device 310 may display visual content to the user on a display screen of the display device 310. Additionally, the display device 310 may present audio content to the user, sense user input, capture audio content, capturing data describing a local area (e.g., with the camera device 305), communicate wirelessly, communicate via wire, determine location, determine a change in position, determining an orientation and/or acceleration, providing haptic feedback, and/or provide some other function. The display screen of the display device 310 may be an embodiment of the display screen 102 or the display screen 202.

The controller 315 may control operations of the camera device 305, the display device 310 and/or some other component(s) of the electronic wearable device 300. The controller 315 may control OIS, autofocusing, actuation, some other operation applied at the camera device 305, or some combination thereof. The controller 315 may also process data captured by the camera device 305. Furthermore, the controller 315 may control any aforementioned functions of the display device 310. In some embodiments, the controller 315 is part of the camera device 305.

The PCB 320 is a stationary component of the electronic wearable device 300 and provides mechanical support (e.g., by acting as a base) for the electronic wearable device 300. The PCB 320 may provide electrical connections for the camera device 305, the display device 310 and the controller 315. The PCB 320 may also electrically connect the controller 315 to the camera device 305 and the display device 310.

FIG. 4A is a cross section of the camera device 305 in an upward (vertical) posture, in accordance with one or more embodiments. The camera device 305 includes a lens barrel 405, a lens assembly 410, a shield case 415, one or more top restoring auto focusing springs 420A, one or more bottom restoring auto focusing springs 420B, one or more OIS suspension wires 423, a carrier 425, one or more actuators 430, one or more auto focusing coils 435, a magnetic assembly 440, an infrared cut-off filter (IRCF) 445, an IRCF holder 450, an image sensor 455, and a PCB 460. The one or more top restoring auto focusing springs 420A together with the one or more bottom restoring auto focusing springs 420B are collectively referred to herein as “one or more restoring auto focusing springs 420.” In alternative configurations, different and/or additional components may be included in the camera device 305. For example, in some embodiments, the camera device 305 may include a controller (not shown in FIG. 4A). In alternative embodiments (as shown in FIG. 3), the controller 315 is a component of the electronic wearable device 300 positioned outside the camera device 305. The upward (vertical) posture of the camera device 305 corresponds to a posture of the camera device 305 where an optical axis 402 of the lens assembly 410 is substantially parallel to gravity (e.g., parallel to y axis in FIG. 4A). On the other hand, the forward (horizontal) posture of the camera device 305 (shown in FIG. 4B) corresponds to a posture of the camera device 305 where the optical axis 402 is substantially orthogonal to gravity (e.g., parallel to x axis in FIG. 4B).

The camera device 305 may be configured to include both a focusing assembly and an OIS assembly. The focusing assembly of the camera device 305 may cause a translation of the lens barrel 405 in a direction parallel to the optical axis 402. The focusing assembly may provide an auto focus functionality for the camera device 305. The focusing assembly may include the one or more restoring auto focusing springs 420, the one or more auto focusing coils 435, and a plurality of magnets included in the magnetic assembly 440. The focusing assembly may include more or fewer components.

The OIS assembly of the camera device 305 may cause a translation of the lens barrel 405 (and, in some embodiments, the magnetic assembly 440 and the lens barrel 405) in one or more directions perpendicular to the optical axis 402. Alternatively or additionally, the OIS assembly may cause a translation of the image sensor 455. The OIS assembly may provide an OIS functionality for the camera device 305 by stabilizing an image projected through the lens barrel 405 to the image sensor 455. The OIS assembly may include the lens barrel 405, the shield case 415, the one or more OIS suspension wires 423, the actuator 430, and the plurality of magnets included in the magnetic assembly 440. The OIS assembly may include more or fewer components. More details about a structure and operations of the OIS assembly are provided below in relation to FIGS. 6A-6B, FIGS. 7A-7B and FIG. 8.

The lens barrel 405 is a mechanical structure or housing for carrying one or more lenses of the lens assembly 410. The lens barrel 405 is a hollow structure with an opening on opposite ends of the lens barrel 405. The openings may provide a path for light (e.g., visible light, infrared light, etc.) to transmit between a local area and the image sensor 455. Inside the lens barrel 405, one or more lenses of the lens assembly 410 are positioned between the two openings. The lens barrel 405 may be manufactured from a wide variety of materials ranging from plastic to metals. In some embodiments, one or more exterior surfaces of the lens barrel 405 are coated with a polymer (e.g., a sub-micron thick polymer). The lens barrel 405 may be rotationally symmetric about the optical axis 402 of the one or more lenses of the lens assembly 410.

The lens barrel 405 may be coupled to the magnetic assembly 440 by the one or more restoring auto focusing springs 420. For example, the one or more restoring auto focusing springs 420 are coupled to the lens barrel 405 and the magnetic assembly 440. In some embodiments, the magnetic assembly 440 is coupled to the shield case 415. In another example (not illustrated), the one or more restoring auto focusing springs 420 are coupled to the shield case 415 directly and the lens barrel 405. The one or more restoring auto focusing springs 420 are configured to control a positioning of the lens barrel 405 along the optical axis 402. For example, the plurality of restoring auto focusing springs 420 may control the positioning of the lens barrel 405 such that when current is not supplied to the one or more auto focusing coils 435 the lens barrel 405 is in a neutral position. In some embodiments, the one or more restoring auto focusing springs 420 may be shape-memory alloy (SMA) wires. The neutral position of the lens barrel 405 is a positioning of the lens barrel 405 when the camera device 305 is not undergoing focusing (via the focusing assembly) nor stabilizing (via the OIS assembly). The one or more restoring auto focusing springs 420 can ensure the lens barrel 405 does not fall out or come into contact with the image sensor 455. In some embodiments, the one or more restoring auto focusing springs 420 are conductors and may be coupled to the one or more auto focusing coils 435. In these embodiments, the plurality of restoring auto focusing springs 420 may be used to provide current to the one or more auto focusing coils 435. The one or more restoring auto focusing springs 420 may be coupled to the one or more OIS suspension wires 423 that provide current to the one or more restoring auto focusing springs 420 so that the one or more restoring auto focusing springs 420 can facilitate auto focusing of the lens assembly 410. The one or more OIS suspension wires 423 may be positioned symmetrically about the optical axis 402.

The shield case 415 may enclose some of the components of the camera device 305 as illustrated in FIG. 4A. In other embodiments (not shown), the shield case 415 may enclose all of the components of the camera device 305. The shield case 415 may partially enclose the lens barrel 405. The shield case 415 may provide a space in which the lens barrel 405 can translate along the optical axis 402 and/or translate in a direction perpendicular to the optical axis 402. In some embodiments, the shield case 415 provides a space in which the lens barrel 405 rotates relative to one or more axes that are perpendicular to the optical axis 402. In some embodiments, the shield case 415 may be rectangular-shaped as illustrated in FIG. 4A. In alternative embodiments, the shield case 415 may be circular, square, hexagonal, or any other shape. In embodiments where the camera device 305 is part of another electronic device (e.g., a smartwatch), the shield case 415 may couple to (e.g., be mounted on, affixed to, attached to, etc.) another component of the electronic device, such as a frame of the electronic device. For example, the shield case 415 may be mounted on a watch body (e.g., the watch body 104) of the smartwatch. The shield case 415 may be manufactured from a wide variety of materials ranging from plastic to metals. In some examples, the shield case 415 is manufactured from a same material as the material of the electronic device the shield case 415 is coupled to such that the shield case 415 is not distinguishable from the rest of the electronic device. In some embodiments, the shield case 415 is manufactured from a material that provides a magnetic shield to surrounding components of the electronic device. In these embodiments, the shield case 415 is a shield can. In some embodiments, one or more interior surfaces of the shield case 415 are coated with a polymer like the lens barrel 405 described above.

The carrier 425 is directly coupled to the lens barrel 405. For example, the carrier 425 comprises a first side in direct contact with a surface of the lens barrel 405 and a second side opposite the first side. In some embodiments, the carrier 425 is coupled to the lens barrel 405 by an adhesive. The one or more auto focusing coils 435 may be affixed to the second side of the carrier 425. The carrier 425 has a curvature that conforms to the curvature of the lens barrel 405. In some embodiments, more than one carrier 425 may be directly coupled to the lens barrel 405. In these embodiments, the number of carriers 425 may match the number of auto focusing coils 435. The carriers 425 may be positioned at unique locations around the lens barrel 405 such that a carrier 425 is positioned between a corresponding auto focusing coil 435 and the lens barrel 405. In some embodiments, the restoring auto focusing springs 420 may be coupled to the carrier 425.

The one or more auto focusing coils 435 are configured to conduct electricity by being supplied with a current. The one or more auto focusing coils 435 may be positioned symmetrically about the optical axis 402. For example, the one or more auto focusing coils 435 may consist of two individual coils positioned symmetrically about the optical axis 402, as illustrated in FIG. 4A. The one or more auto focusing coils 435 are coupled to the one or more actuators 430 and provide the current to the one or more actuators 430.

The one or more actuators 430 are configured to provide auto focusing to the one or more lenses of the lens assembly 410. The one or more actuators 430 consume an auto focusing actuation power while providing auto focusing to the one or more lenses of the lens assembly 410. To reduce (and in some cases minimize) a level of the auto focusing actuation power consumption (e.g., to achieve the zero level auto focusing actuation power), relative positions of the lens assembly 410, the carrier 425 and the one or more actuators 430 along the optical axis 402 may be controlled during assembling of the camera device 305.

The magnetic assembly 440 includes a magnet holder for holding a plurality of magnets. The magnet holder may provide a rigid structure to support the plurality of magnets. In some embodiments, the magnet holder may enclose all sides of the magnets. In other embodiments, the magnet holder may enclose all sides of the magnets except for a side facing the one or more auto focusing coils 435. In some embodiments, one or more exterior surfaces of the magnetic assembly 440 are coated with a polymer like the lens barrel 405 described above.

The plurality of magnets of the magnetic assembly 440 generate magnetic fields that can be used for translating the lens barrel 405 along the optical axis 402 (e.g., focusing the camera device 305) and/or perpendicular to the optical axis 402 (e.g., providing OIS for the camera device 305). The magnetic fields used for focusing the camera device 305 can be applied in the forward (horizontal) posture of the camera device 305, e.g., to focus the lens assembly 410 at the hyperfocal distance.

Each magnet of the plurality of magnets may be of a different size or of the same size. In some embodiments, each magnet is curved about the optical axis 402 conforming to the curvature of the one or more auto focusing coils 435 and the lens barrel 405. In some embodiments, each magnet is straight. For example, at least two opposing sides of each magnet may be parallel to a plane that is parallel to the optical axis 402. Each magnet of the plurality of magnets may include rectangular cross sections with one axis of a cross section being parallel to the optical axis 402 and another axis of the cross section being perpendicular to the optical axis 402. In some embodiments, each magnet may include other types of cross-sectional shapes such as square or any other shape that includes at least one straight-edged side that faces the one or more auto focusing coils 435. Each magnet may be a permanent magnet that is radially magnetized with respect to the optical axis 402. The magnets may be positioned symmetrically or asymmetrically about the optical axis 402. More details about the structure of magnets of the magnetic assembly 440 are provided below in relation to FIGS. 6A-6B.

The image sensor 455 captures data (e.g., one or more images) describing a local area. The image sensor 455 may include one or more individual sensors, e.g., a photodetector, a CMOS sensor, a CCD sensor, some other device for detecting light, or some combination thereof. The individual sensors may be in an array. For a camera device 305 integrated into an electronic device, the local area is an area surrounding the electronic device. The image sensor 455 captures light from the local area. The image sensor 455 may capture visible light and/or infrared light from the local area surrounding the electronic device. The visible and/or infrared light is focused from the local area to the image sensor 455 via the lens barrel 405. The image sensor 455 may include various filters, such as the IRCF 445. The IRCF 445 is a filter configured to block the infrared light from the local area and propagate the visible light to the image sensor 455. The IRCF 445 may be placed within the IRCF holder 450.

The PCB 460 is positioned below the image sensor 455 along the optical axis 402. The PCB 460 is a stationary component of the camera device 305 and provides mechanical support (e.g., by acting as a base) for the camera device 305. The PCB 460 may provide electrical connections for one or more components of the camera device 305. In some embodiments, a controller may be located on the PCB 460 and the PCB 460 electrically connects the controller to various components (e.g., the one or more auto focusing coils 435, the one or more OIS suspension wires 423, etc.) of the camera device 305. In other embodiments (as shown in FIG. 3), the controller 320 is located externally to the camera device 305.

FIG. 4B is a cross section of the camera device 305 in a forward (horizontal) posture, in accordance with one or more embodiments. The cross section of the camera device 305 in FIG. 4B corresponds to the most typical use case of the camera device 305 at which the one or more lenses of the lens assembly 410 are also in the horizontal posture. At the forward posture of the camera device 305, the OIS assembly may provide that a center axis of the image sensor 455 and the optical axis 402 substantially overlap. Furthermore, at the forward posture of the camera device 305, the lens assembly 410 may be at a hyperfocal position relative to the image sensor 455. The hyperfocal position of the lens assembly 410 corresponds to a position of the lens assembly 410 within the camera device 305 at which the lens assembly 410 is focused at a hyperfocal distance within a local area (e.g., 1.7 meter) when the camera device 305 is at the forward posture.

### Optical Image Stabilization

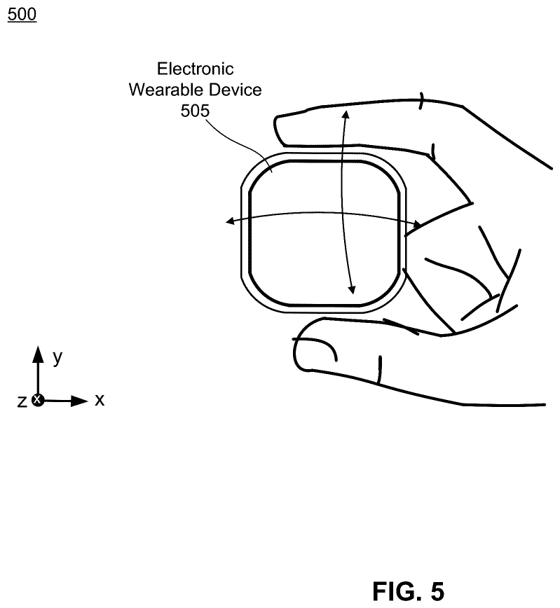

FIG. 5 illustrates an example movement 500 of an electronic wearable device 505 along two spatial dimensions, in accordance with one or more embodiments. As shown in FIG. 5, the electronic wearable device 505 (e.g., smartwatch) may be moved by a user along a first direction parallel to x axis and/or along a second direction parallel to y axis (e.g., along one or two spatial dimensions) while achieving a specific exposure of its camera device. In some cases, z axis is substantially orthogonal to the gravity vector. The wearable device 505 may be an embodiment of the electronic wearable device 300, i.e., the wearable device 505 may include the camera device 305.

The objective is to compensate blur in an image taken by the camera device of the wearable device 505 introduced due to a hand motion (including rotation about x axis) occurring while the image is being taken (i.e., during an exposure of the camera device). To reduce a level of blur in the image taken by the camera device, OIS may be applied (e.g., by the OIS assembly of the camera device 305, and the controller 315). For example, movement (which may include rotation) of an optical axis during an exposure of the camera device may introduce shift in projection point at an image sensor of the camera device, which causes that a blurred image is produced. The camera device may rotate around at least one axis (e.g., x axis) when changing orientation from a first orientation (e.g., upward, or vertical posture) to a second orientation (e.g., forward, or horizontal posture) during the exposure.

The blur can be reduced (i.e., completely avoided or mitigated below a threshold level) by shifting a lens assembly and/or an image sensor of the camera device, i.e., by applying stroke(s) of the lens assembly and/or the image sensor, which may be initiated by an OIS assembly of the camera device. The amount of shift (i.e., stroke) may be a function of focal length of the lens and a rotation angle. Longer exposures of the camera device may require a longer stroke to sufficiently reduce blur in an image being taken by the camera device. The OIS assembly may initiate a motion (shifting) of the lens assembly and/or the image sensor responsive to the camera device changing orientation from the first orientation to the second orientation during the exposure.

FIG. 6A illustrates an example OIS assembly 600 of a camera device (e.g., the camera device 305) with a symmetric stroke map 602, in accordance with one or more embodiments. The OIS assembly 600 may include drive magnets 605A, 605B, 605C and 605D positioned around an actuator 610 along axes parallel to a first axis (e.g., x axis) and a second axis (e.g., y axis). The drive magnets 605A though 605D may be magnets of the magnetic assembly 440, and the actuator 610 may be an embodiment of the actuator 430. The OIS assembly 600 may include more or fewer components than what is shown in FIG. 6A. The drive magnets 605A, 605C may be mutually identical and positioned such that their longest dimension (e.g., length) is along an axis parallel to the first axis. And the drive magnets 605B, 605D may be mutually identical and positioned such that their longest dimension (e.g., length) is along an axis parallel to the second axis. Furthermore, a longest dimension (e.g., length) of each drive magnet 605A, 605C is the same as a longest dimension (e.g., length) of each drive magnet 605B, 605D.

The drive magnets 605A, 605C may cause a first motion of the actuator 610 along a first direction parallel to the second axis, which further causes a first motion of a lens assembly (e.g., the lens assembly 410) and/or an image sensor (e.g., the image sensor 455) along the first direction. Similarly, the drive magnets 605B, 605D may cause a second motion of the actuator 610 along a second direction parallel to the first axis, which further causes a second motion of the lens assembly and/or the image sensor along the second direction. As the longest dimensions of the drive magnets 605A through 605D along corresponding axes are the same, the stroke map 602 produced by the OIS assembly 600 is symmetric relative to an optical center 604 for both the first and second axes. The optical center 604 may correspond to an optical center of the lens assembly and/or the image sensor. A first range of the first motion (i.e., stroke range) along the first direction parallel to the second axis may be between −S and S, and a second range of the second motion (i.e., stroke range) along the second direction parallel to the first axis may be also between −S and S (e.g., S=100 μm), i.e., the stroke map 602 may be symmetric for both the first and second axes.

FIG. 6B illustrates an example OIS assembly 620 of a camera device (e.g., the camera device 305) with an asymmetric stroke map 622, in accordance with one or more embodiments. The OIS assembly 620 may include drive magnets 625A, 625B, 625C and 625D positioned along axes parallel to a first axis (e.g., x axis) and a second axis (e.g., y axis), around an actuator 630. The drive magnets 625A though 625D may be magnets of the magnetic assembly 440, and the actuator 630 may be an embodiment of the actuator 430. The OIS assembly 620 may include more or fewer components than what is shown in FIG. 6B. The drive magnets 625A, 625C may be mutually identical and positioned such that their longest dimension (e.g., length) is along an axis parallel to the first axis. And the drive magnets 625B, 625D may be mutually identical and positioned such that their longest dimension (e.g., length) is along an axis parallel to the second axis. However, a longest dimension (e.g., length) of each drive magnet 625A, 625C is different than a longest dimension (e.g., length) of each drive magnet 625B, 625D. As illustrated in FIG. 6B, the longest dimension of each drive magnet 625B, 625D along the axis parallel to the second axis is smaller than the longest dimension of each drive magnet 625A, 625C along the axis parallel to the first axis. In other words, smaller drive magnets 625B, 625D may be used along the axis parallel to the first axis (e.g., x axis) along which a smaller stroke may be required. On the other hand, larger drive magnets 625A, 625C may be employed along the axis parallel to the second axis (e.g., y axis) along which a longer stroke may be required.

The drive magnets 625A, 625C may cause a first motion of the actuator 630 along a first direction parallel to the second axis, which further causes a first motion of a lens assembly (e.g., the lens assembly 410) and/or an image sensor (e.g., the image sensor 455) along the first direction. Similarly, the drive magnets 625B, 625D may cause a second motion of the actuator 630 along a second direction parallel to the first axis, which further causes a second motion of the lens assembly and/or the image sensor along the second direction. As the longest dimension of the drive magnets 625A, 625C is longer than the longest dimension of the drive magnets 625B, 625D, the stroke map 622 that can be produced by the OIS assembly 620 features a longer stroke along the second axis (i.e., controlled by the drive magnets 625A, 625C) than along the first axis (i.e., controlled by the drive magnets 625B, 625D). Since the drive magnets 625A, 625C are identical, a first stroke range along the second axis (e.g., y axis) is symmetrical about an optical center 624, i.e., the first stroke range may be between −Sy and Sy (e.g., Sy=130 μm). Similarly, since the drive magnets 625B, 625B are identical, a second stroke range along the first axis (e.g., x axis) is symmetrical about the optical center 624, i.e., the second stroke range may be between −Sx and Sx (e.g., Sx=70 μm). However, it should be noted that the first stoke range (e.g., 2Sy=260 μm) is longer than second stoke range (e.g., 2Sx=140 μm). The optical center 624 may correspond to an optical center of the lens assembly and/or the image sensor.

In some embodiments, the actuator 630 actuates the first motion of the lens assembly and/or the image sensor along the second axis, as well as the second motion of the lens assembly and/or the image sensor along the first axis, based on one or more signals from the OIS assembly. The first range of the first motion and the second range of the second motion may depend on a stiffness of one or more springs (e.g., auto focusing springs 420 and/or OIS suspension wires 423) coupled to the actuator 630 (not shown in FIG. 6B). For example, a first stiffness of a first spring coupled to the actuator 630 along an axis parallel to the first axis may be larger than a second stiffness of a second spring coupled to the actuator 630 along an axis parallel to the second axis, thus resulting into a shorter stroke along a direction parallel to the first axis (e.g., x axis) and a longer stroke along a direction parallel to the second axis (e.g., y axis). Additionally or alternatively, the first range of the first motion and the second range of the second motion may depend on a strength of one or more coils (e.g., auto focusing coils 435) of the actuator 630 (not shown in FIG. 6B). For example, a first strength of a first coil coupled to the actuator 630 along an axis parallel to the first axis may be smaller than a second strength of a second coil coupled to the actuator 630 along an axis parallel to the second axis, thus resulting into a shorter stroke along a direction parallel to the first axis (e.g., x axis) and a longer stroke along a direction parallel to the second axis (e.g., y axis).

FIG. 7A illustrates an example motion profile of an actuator 702 of a camera device (e.g., the camera device 305), in accordance with one or more embodiments. The actuator 702 may be an embodiment of the actuator 430. The actuator 702 may be coupled to an actuator coil 704 that may provide for shifting of a lens assembly (e.g., the lens assembly 410) along one or more directions parallel to one or more axes (e.g., x axis and/or y axis). The motion profile of the actuator 702 is illustrated in FIG. 7A through motion steps 705, 710, 715 during an exposure of the camera device when an image is being taken while pressing a control button of an electronic wearable device (e.g., the button 208 of the watch body 204 in FIG. 2B). The motion steps 705 through 715 show rotation of the actuator 702 about x axis while the button is being pressed. In addition to providing the asymmetric stroke between directions parallel to x and y axes (e.g., as described above in relation to FIG. 6B), the actuator 702 of the camera device may be designed to be asymmetric along one or more axes parallel to x and/or y axes, thus providing further stroke asymmetry between directions parallel to x and y axes.

FIG. 7B illustrates an example stroke map 720 of a camera device (e.g., the camera device 305) for compensating a larger motion of the camera device in one direction, in accordance with one or more embodiments. The stroke map 720 may be achieved by employing an OIS assembly of the camera device that includes the asymmetric actuator 702. Additionally or alternatively to designing the asymmetric actuator 702, the stroke map 720 may be achieved by designing drive magnets (e.g., of the magnetic assembly 440) with a longest dimension (e.g., length) along an axis parallel to the x axis as asymmetric magnets. For example, the drive magnets 625A and 625C in FIG. 6B may be designed to have different dimensions (lengths) along an axis parallel to the x axis, with the drive magnet 625C having a longer dimension along the axis parallel to the x axis than the drive magnet 625A, thus providing a longer stroke along a direction of the negative y axis compared to a stroke along a direction of the positive y axis.

The stroke map 720 features more stroke along the direction of the negative y axis (i.e., the portion of y axis below an optical center 722) compared to the direction of the positive y axis (i.e., the portion of y axis above the optical center 722) to compensate a larger motion in that direction when a control button (e.g., the button 208) is being pressed during an exposure of the camera device. A stroke range along the axis parallel to the y axis may be therefore asymmetrical about the optical center 722, i.e., the stroke range along the axis parallel to the y axis may be between −Sy₁ and Sy₂ (e.g., Sy₁=140 μm, and Sy₂=100 μm). The stroke map 720 further features more stroke along the axis parallel to the y axis compared to the axis parallel to the x axis, as more stroke is desired along a direction of a button motion (e.g., direction along the y axis) compared to another orthogonal direction (e.g., direction along the x axis). A stroke range along the direction parallel to the x axis may be symmetrical about the optical center 722 but smaller than the stroke range along the direction parallel to the y axis, i.e., the stroke range along the direction parallel to the x axis may be between −Sx and Sx (e.g., Sx=70 μm).

FIG. 8 is a flowchart illustrating a process 800 of initiating an asymmetric stroke at a camera device for OIS, in accordance with one or more embodiments. Steps of the process 800 may be performed by one or more components of the camera device (e.g., the camera device 305). Embodiments may include different and/or additional steps of the process 800, or perform the steps of the process 800 in different orders.

The camera device initiates 805 (e.g., via an OIS assembly) a first motion of at least one of an image sensor and a lens assembly in the camera device along a first direction parallel to a first axis (e.g., horizontal axis or x axis), the first motion having a first range. The camera device initiates 810 (e.g., via the OIS assembly) a second motion of at least one of the image sensor and the lens assembly along a second direction parallel to a second axis (e.g., vertical axis or y axis) orthogonal to the first axis, the second motion having a second range different (e.g., longer) than the first range.

In some embodiments, the camera device initiates (e.g., via the OIS assembly) the first motion and the second motion responsive to the camera device changing orientation from a first orientation (e.g., vertical, or upward orientation) to a second orientation (e.g., horizontal, or forward orientation). An optical axis of the lens assembly is parallel to gravity when the camera assembly is at the first orientation, and the optical axis is orthogonal to gravity when the camera device is at the second orientation. The camera device may rotate around the first axis when the camera device changes orientation from the first orientation to the second orientation. The first range may be symmetric about the second axis, and the second range may be symmetric about the first axis. Alternatively, the first range may be symmetric about the second axis, and the second range may be asymmetric about the first axis. A central axis of the image sensor may substantially overlap with an optical axis of the lens assembly after the first motion and the second motion.

In some embodiments, the OIS assembly includes a first pair of magnets each positioned around an axis parallel to the first axis, and a second pair of magnets each positioned around an axis parallel to the second axis. A first dimension of each magnet from the first pair along the axis parallel to the second axis may be smaller than a second dimension of each magnet from the second pair along the axis parallel to the first axis. A dimension of a magnet from the second pair along the axis parallel to the first axis may be different than another dimension of another magnet from the second pair along the axis parallel to the first axis.

In some embodiments, the camera device includes one or more actuators configured to actuate the first motion and the second motion based on one or more signals from the OIS assembly. The first range and the second range may depend on a stiffness of one or more springs coupled to the one or more actuators. Alternatively or additionally, the first range and the second range may depend on a strength of one or more coils of the one or more actuators.

### Lens Alignment for Integrated Lens Barrel Structure

Embodiments of the present disclosure are further directed to a method and apparatus for performing lens alignment for an integrated lens barrel structure. The method and apparatus presented herein can be utilized for any type of lens, including a lens that requires activation during the lens assembly. The method and apparatus presented herein allows installation of an actuated lens, making the installation process compatible with the existing lens assembly process.

A lens reference alignment apparatus is presented herein that aligns a targeted lens (e.g., a lens of the lens assembly 410) to a reference system before installation of the targeted lens into a lens barrel (e.g., the lens barrel 405). The targeted lens can be activated if required during the optical alignment process. The optical alignment process presented herein can be parallelized for all lens elements or for selected lens elements. When installing the targeted lens to the lens barrel, the targeted lens and the reference system can be aligned as a whole to the lens barrel. A second optical alignment process can be performed during the lens installation, but without having to activate the targeted lens. The assembly accuracy and precision is mainly dominated by the performance of a positioning system of the lens barrel stage and the reference alignment apparatus.

The optical alignment process may start by selecting a lens A as a targeted lens for installation into a lens barrel. The lens A may be optically aligned and attached to a reference system. After that, the lens A may be installed into the lens barrel. Another lens, lens B, may be then selected as a targeted lens for installation into the lens barrel. The lens B may be optically aligned and attached to the same reference system. After that, the reference system with the lens B attached to the reference system may be aligned to the lens barrel. If required, the lens B may be optically aligned to the lens barrel. Finally, the lens B may be installed into the lens barrel.

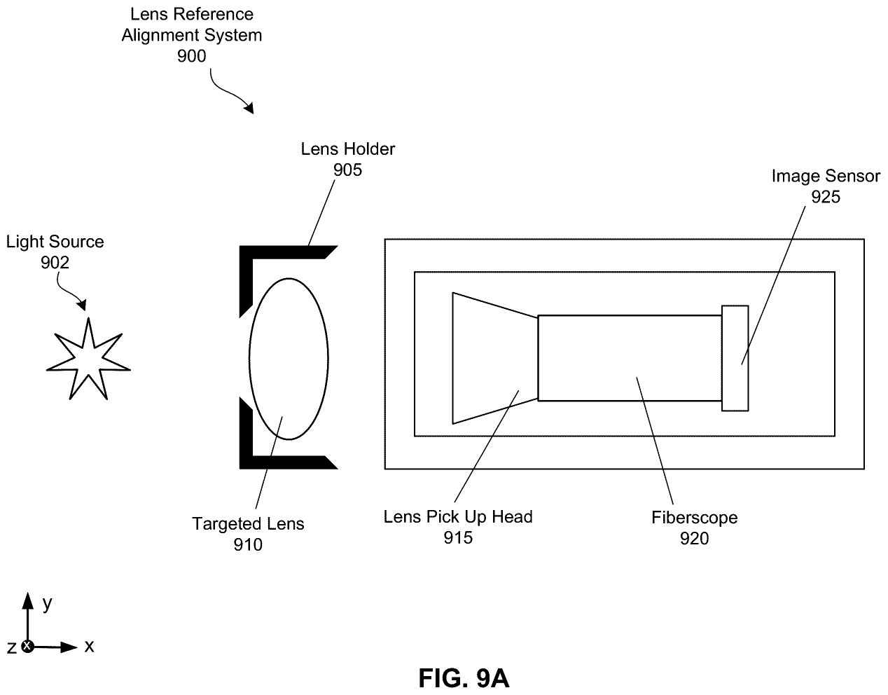

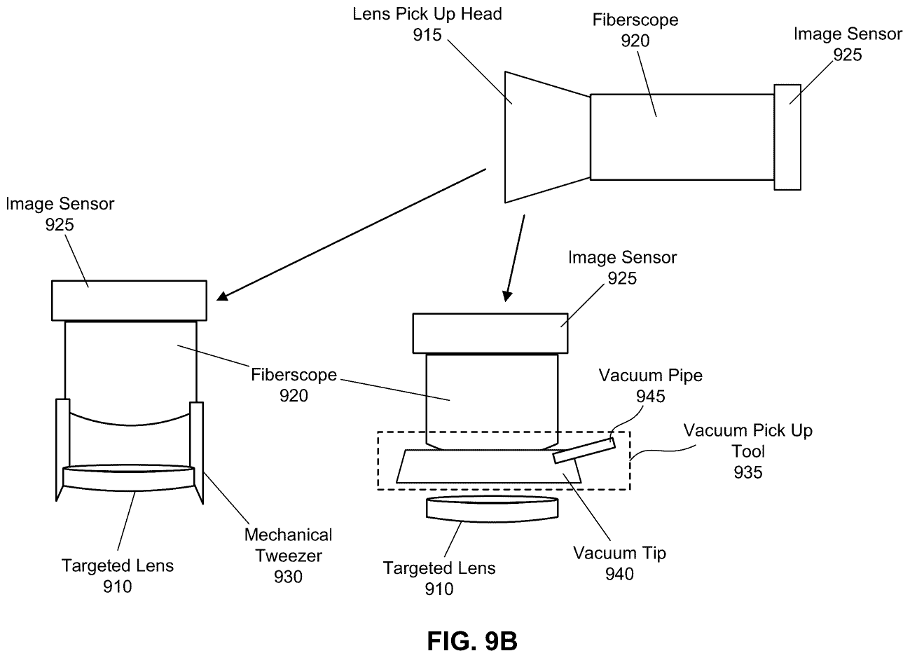

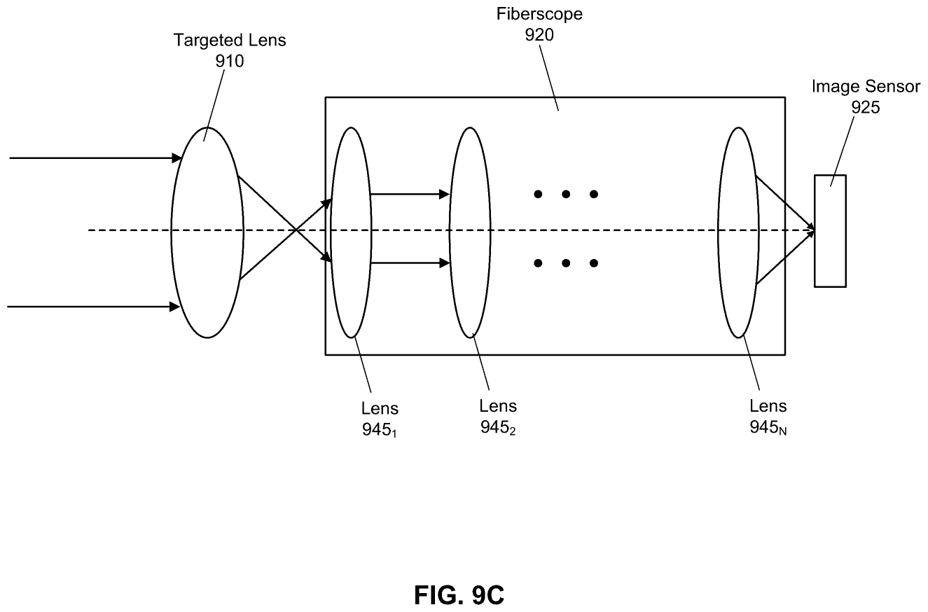

FIG. 9A illustrates an example lens reference alignment system 900, in accordance with one or more embodiments. The lens reference alignment system 900 may include a lens holder 905, a lens pick up head 915, a fiberscope 920 (or optical imaging system), and an image sensor 925. In some embodiments, the lens holder may be a component separate from the lens reference alignment system 900. The lens holder 905 may be a high precision apparatus for holding a targeted lens 910, and a position of the lens holder 905 in space may be precisely controlled. The lens pick up head 915 may be a high precision apparatus for picking up and transferring the lens 910 with very high position precision and accuracy. The fiberscope 920 may include one or more optical imaging components for directing light from a light source 902 towards the image sensor 925. The image sensor 925 may capture images of one or more objects in a local area of the lens reference alignment system 900. The lens reference alignment system 900 as a whole may be a high precision equipment, with its position in space precisely controlled.

FIG. 9B illustrates an example lens pick up head 915 of the lens reference alignment system 900, in accordance with one or more embodiments. As the targeted lens 910 requires to be handled in a clean environment, the lens pick up head 915 cannot introduce any debris and residue to a surface of the targeted lens 910. The lens pick up head 915 may pick up and transfer the targeted lens 910 with a very high position precision and accuracy. The lens pick up head 915 may be able to hold the targeted lens 910 firmly without slipping. The lens pick up head 915 may place the targeted lens 910 into a structure (e.g., into the lens holder 905 or a lens barrel) and released without introducing any positional change. Furthermore, the lens pick up head 915 may release the targeted lens 910 without any adhesion.

In one embodiment, the lens pick up head 915 is implemented as a mechanical tweezer 930. The mechanical tweezer 930 may include at least two tweezer tips or mechanical grippers in order to have a good force balance on the targeted lens 910. The mechanical tweezer 930 may not block an optical path of the targeted lens 910. In another embodiment, the lens pick up head 915 is implemented as a vacuum pick up tool 935 (e.g., tip/chuck). A center of a vacuum tip 940 of the vacuum pick up tool 935 may be reserved for the fiberscope 920. A vacuum pipe 945 of the vacuum pick up tool 935 may be connected to a rubber tip on a side of the vacuum tip 940. The vacuum tip 940 may adjust a vacuum pressure based on properties of the targeted lens 910. The vacuum pick up tool 935 may not block an optical path of the targeted lens 910.

FIG. 9C illustrates an example fiberscope 920 (or optical imaging system) of the lens reference alignment system 900, in accordance with one or more embodiments. The fiberscope 920 may be attached to the lens pick up head 915. The fiberscope may include one or more lenses, e.g., lens 945₁, lens 945₂, . . . , lens 945_{N} in optical series, where N>1. The fiberscope 920 may move together with the lens pick up head 915, and relative positions of the fiberscope 920 and the lens pick up head 915 may be fixed and consistent under all conditions. The fiberscope 920 may be very flexible and suitable for bending. The fiberscope 920 may not introduce any imaging distortions, so the imaging quality is mainly determined by the quality of optical alignment of the targeted lens 910.

The image sensor 925 of the lens reference alignment system 900 may be attached at one end of the fiberscope 920. The image sensor 925 may be swappable. The image sensor 925 may be of a same type as an image sensor of a camera device. The image sensor 925 may capture images of one or more objects in a local area. The quality of captured images (or other type of metrics) may be analyzed by, e.g., a computer (or vision processor, or controller) in real time. The image quality results may be used as a reference for a first optical alignment of the targeted lens 910.

The targeted lens 910 may be placed on the lens holder 905. A diameter of the lens holder 905 may be adjusted to accommodate target lenses of different sizes. A position (e.g., x, y, z, angles) of the lens holder 905 may be controlled and adjusted during the first optical alignment process. The position accuracy may need to be better than, e.g., In some embodiments, light sources, optical stops, apertures, and objects can be placed next to the lens holder 905.

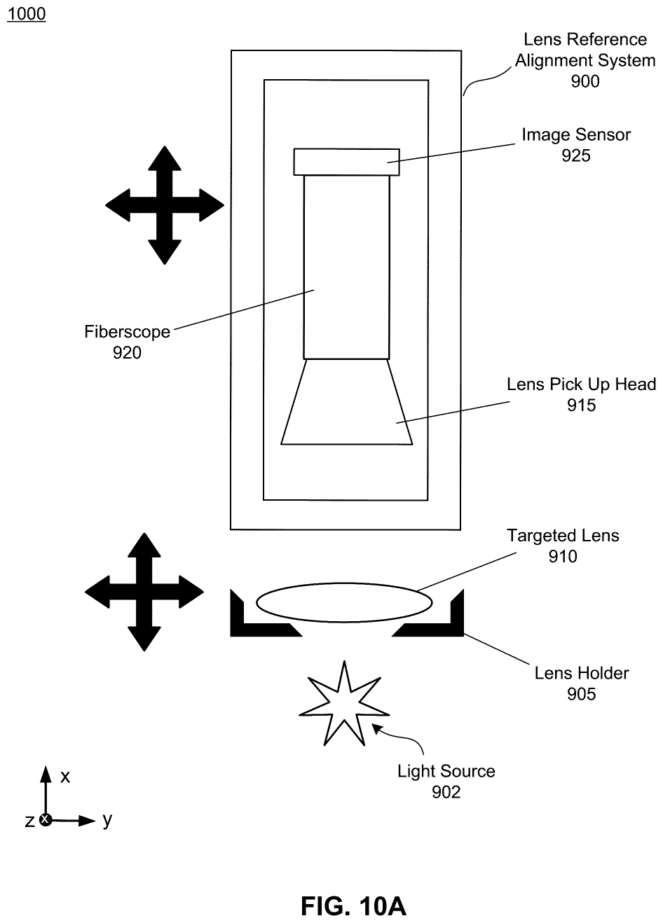

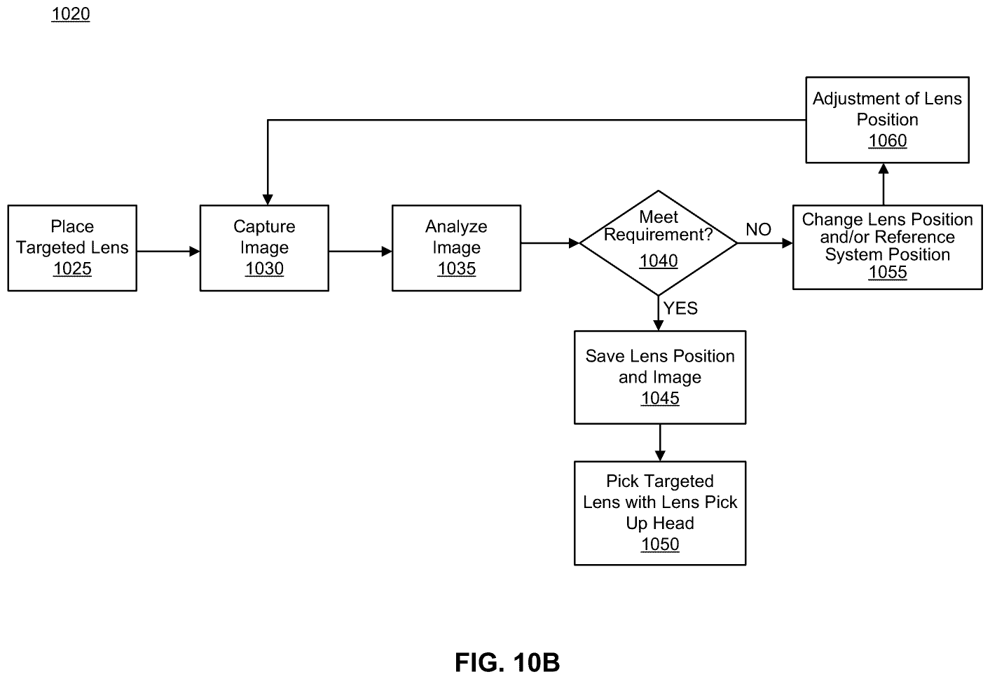

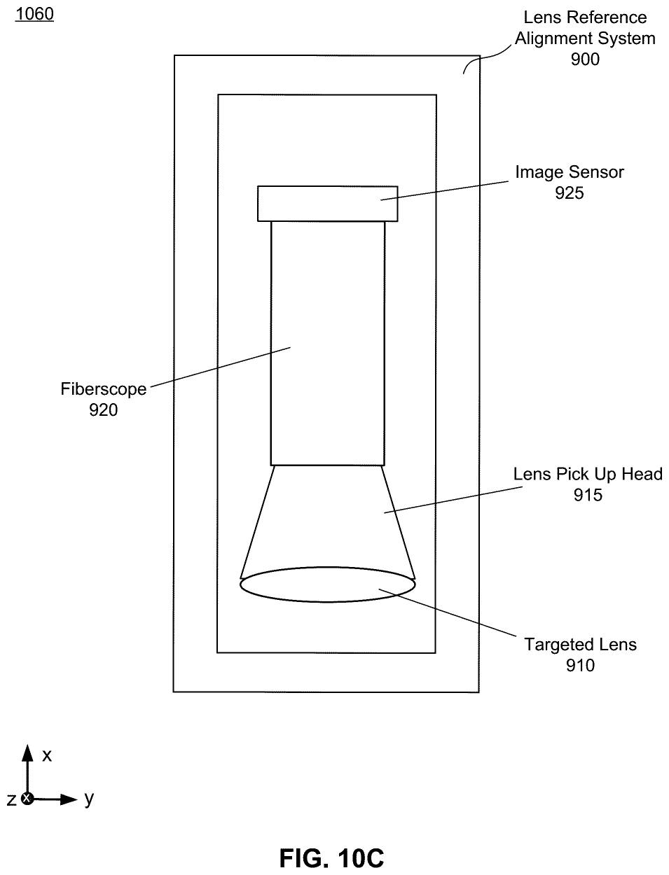

FIG. 10A illustrates an example alignment 1000 of the lens reference alignment system 900, in accordance with one or more embodiments. The lens holder 905 and the lens reference alignment system 900 can be moved and/or rotated by a high precision mechanism, such as a robotic arm or stage. A quality of an image captured by the image sensor 925 may be analyzed and used as a feedback for a position adjustment of the lens holder 905 and/or the lens reference alignment system 900 as a whole.

FIG. 10B illustrates an example process 1020 of the lens reference optical alignment, in accordance with one or more embodiments. At 1025, the targeted lens 910 may be placed at the lens holder 905. At 1030, the image sensor 925 may capture an image of an object in a local area of the lens reference alignment system 900. At 1035, a computer (or vision processor, or controller) may analyze a quality of the captured image. At 1040, a decision may be made whether an alignment requirement has been met. If the alignment requirement has been met, at 1045, a position of the targeted lens 910 and the captured image may be saved (e.g., at a memory of the computer). At 1050, the lens pick up head 915 may pick the targeted lens 910. Otherwise, if the alignment requirement has not been met, at 1055, a command may be issued (e.g., by the computer) to change a position of the targeted lens 910 and/or a position of the lens reference alignment system 900. At 1060, a position adjustment for the targeted lens 910 may be made. After that, the process 1020 returns to the step 1030, and the image sensor 925 may capture a new image of the object in the local area, and the steps 1035 and 1040 are repeated until the alignment requirement is met.

There are several steps for performing an optical adjustment of the lens holder 905. First, an object position and location may be fixed. A position and location of the lens holder 905 can be adjusted in order to reach a desired image quality metric. The position and location of the lens holder 905 may be adjusted in all three spatial directions (e.g., x, y, z directions), pitch direction, roll direction, and yaw direction with very high accuracy and precision. The targeted lens 910 may be placed in the lens holder 905 and move together with the lens holder 905 without slipping. The targeted lens 910 may stay still after motion of the lens holder 905 is stopped.

There are several steps for performing an optical adjustment of the lens reference alignment system 900. The lens reference alignment system 900 may change its position as a whole piece of equipment. The lens reference alignment system 900 may adjust its position in all three spatial directions (e.g., x, y, z directions), pitch direction, yaw direction, and roll direction with very high accuracy and precision. The lens reference alignment system 900 may stay still after an image captured by the image sensor 925 meets image quality requirements.

If the targeted lens 910 has an actuator (e.g., a tunable lens actuator or OIS actuator), the actuator may be turned on so that the targeted lens is placed into, e.g., one actuated state or two actuated states during the reference alignment process. Power supply circuits and a driver may be mounted next to the lens holder 905 to provide a desired power profile during the lens reference alignment process. The process of activating the targeted lens 910 during the lens reference alignment process may start by placing the targeted lens 910 in the lens holder 905. After that, the targeted lens 910 may be activated by a desired power profile. Then, the lens-reference optical alignment may be performed, followed by picking up the targeted lens 910 by the lens pick up head 915. At the end, the power applied to the targeted lens 910 may be turned off.

FIG. 10C illustrates an example final state 1060 after the lens reference alignment and lens pick up, in accordance with one or more embodiments. The lens holder 905 and the lens reference alignment system 900 may be moved separately. Alternatively, one of the lens holder and the lens reference alignment system 900 may be moved while the other one may be fixed in order to reach a desired image quality metric for the optical alignment. After the optical alignment is performed, all position adjustments may be stopped. The lens pick up process may not introduce any relative motions between the targeted lens 910 and the lens pick up head 915. The lens pick up head 915 and the targeted lens 910 may move together to a lens barrel.

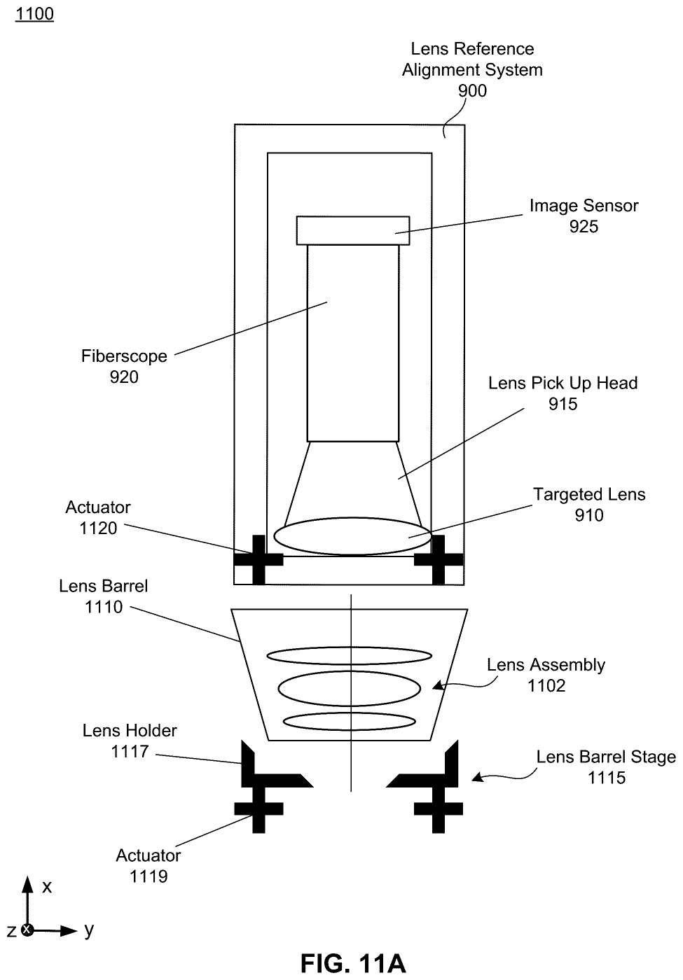

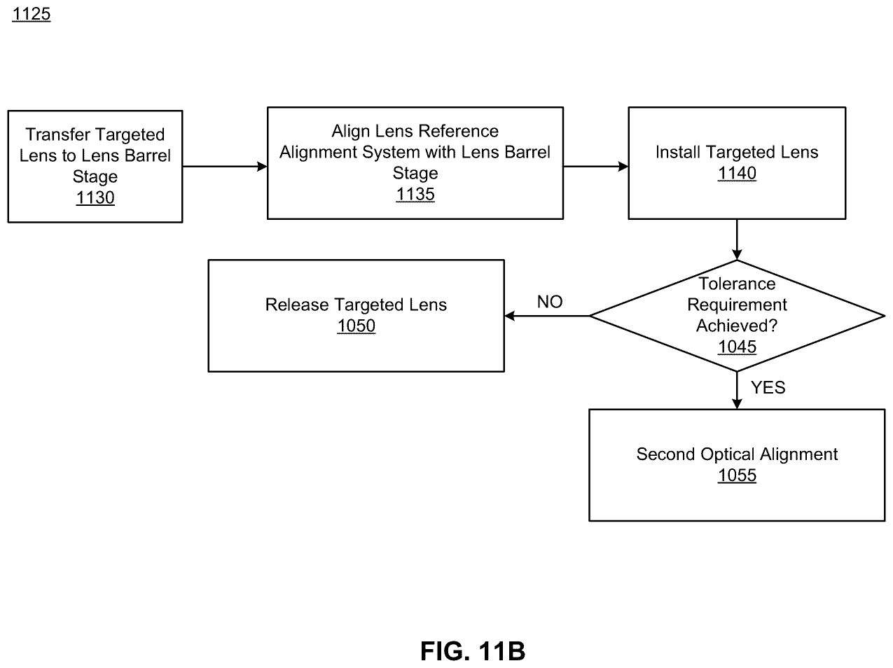

FIG. 11A illustrates an example installation 1100 of a lens assembly 1105 into a lens barrel 1110, in accordance with one or more embodiments. The lens assembly 1102 may include a plurality of optical elements (e.g., lenses). The lens pick up head 915 (and the lens reference alignment system 900 as a whole) and the targeted lens 910 may move together to a lens barrel stage 1115. The lens barrel stage 1115 may include a lens holder 1117 and an actuator 1119. In some embodiments, an actuator 1120 may be applied to switch the targeted lens 910 into an active state during an optical alignment. The relative position of the lens reference alignment system 900 and the lens barrel may be accurately controlled. If needed, a mark alignment, laser alignment or positioning sensor may be employed to control the relative position of the lens reference alignment system 900 and the lens barrel. The lens pick up head 915 may release the targeted lens 910 to the lens barrel. If there is a stricter requirement for the lens assembly, a second optical alignment following the first optical alignment can be performed.

FIG. 11B illustrates an example process 1125 of a lens assembly installation, in accordance with one or more embodiments. At 1130, the targeted lens 910 may be transferred to the lens barrel stage. At 1135, the lens reference alignment system 900 may be aligned with the lens barrel stage. At 1140, the targeted lens 910 may be installed. At 1145, a decision may be made whether the tolerance requirement has been achieved. If not, at 1150, the targeted lens 910 may be released. If the tolerance requirement has been achieved, then, at 1155, the second optical alignment may be performed.

If there is a stricter requirement for the optical alignment of lens assembly, the second optical alignment may be performed. During the second optical alignment, a position of the lens barrel and the lens reference alignment system 900 (together with the targeted lens 910) may be adjusted relatively to meet a requirement of image quality (or one or more other quality metrics). The targeted lens 910 may not need to be activated during this optical alignment process. The optical imaging behavior of the targeted lens 910 and the lens reference alignment system 900 may become known during the prior alignment, and this information can be used to facilitate the second optical alignment.

In order to access imaging performance, the targeted lens 910 may not be powered in this final lens assembly/installation process. The imaging performance of the targeted lens 910 (which is power on or powered off) and the lens reference alignment system 900 may become known during the first optical alignment. The imaging performance of the targeted lens 910 at zero power, reference alignment, and the installed lens barrel may be obtained during the second optical alignment. Then, the imaging performance of the targeted lens 910 at a desired power may be assessed from the imaging performance of the targeted lens 910 and the lens reference alignment system 900 in the first optical alignment, and the imaging performance of the targeted lens 910 at zero power.

The optical alignment processes presented herein can be performed automatically. The first optical alignment (i.e., lens to reference alignment) may be performed in parallel for all lenses. However, the second optical alignment may be performed in sequence to the first optical alignment. If the lens barrel has very good tolerance control and there is no need to perform the optical alignment for each lens, the first optical alignment may be bypassed for one or more lenses in the lens assembly. Hoverer, a tunable lens, or a lens with an actuator may still need to go through the first optical alignment for achieving improved optical alignment.

A new camera lens assembly and installation procedure and an alignment apparatus are presented herein. A targeted lens can be first optically aligned to a lens reference alignment system. The lens reference alignment system moves the targeted lens to the lens barrel with very high positioning accuracy and precision control. A second optical alignment between the lens barrel (with already installed targeted lens) and the targeted lens can be performed to further reduce an alignment error. The alignment error mainly depends on the position accuracy of the lens reference alignment system and the lens barrel stage, both of which can be better than, e.g., 1 μm. All optical alignment processes can be performed automatically, and the first optical alignment can be performed in parallel for multiple targeted lenses of a lens assembly to increase the productivity in mass production.

There are several benefits of the lens alignment process and the alignment apparatus presented herein. First, there is no need to activate a tunable lens or an actuator during the lens installation process. Second, improved assembly precision and accuracy can be achieved because each lens of a lens assembly can be aligned to the same reference. Third, there is more flexibility in the assembly. For example, if a particular lens has worse performance than expected, the alignment process for that lens can be repeated until the performance requirements are met, and there is no need to perform repeated alignment process for lenses that immediately meet the performance requirements. Fourth, there is a relaxed tolerance requirement for the targeted lens and the lens barrel because the optical alignment can be performed for each lens and in each installation. Because of that, the camera module yield can be higher.

### Metal Insert Molded Lens Barrel

Embodiments of the present disclosure are further directed to a lens barrel with a metal insert that minimizes thermal mechanical stresses. In some embodiments, the lens barrel includes a metal insert that floats in space. In some other embodiments, the lens barrel includes an L-shape metal insert that converts a longitude deformation to a bending mode, of which the stiffness or stress is reduced by at least one order of magnitude. Embodiments of the present disclosure are further directed to molding methods to fabricate a floating metal insert and an L-shape metal insert within a lens barrel.

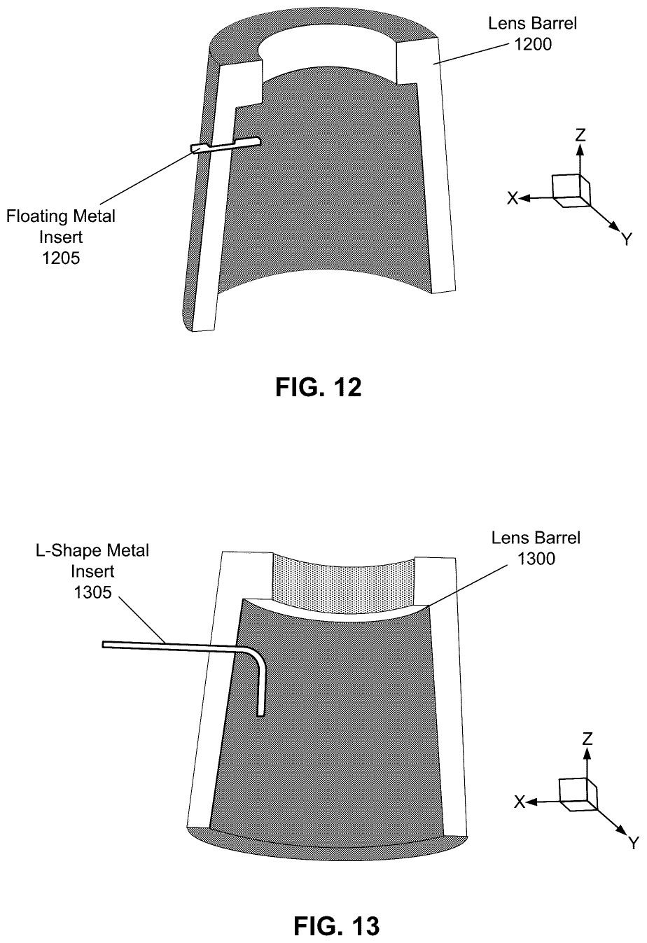

FIG. 12 illustrates an example lens barrel 1200 with a floating metal insert 1205, in accordance with one or more embodiments. The floating metal insert 1205 may minimize the thermal mechanical stresses by floating in the space. Most of a body of the floating metal insert 1205 may be set to be free in the space. The floating metal insert 1205 may have a smaller coefficient of thermal expansion (CTE) than the lens barrel 1200. Thus, the floating metal insert 1205 may have less thermal deformation than the lens barrel 1200.

FIG. 13 illustrates an example lens barrel 1300 with an L-shape metal insert 1305, in accordance with one or more embodiments. The L-shape metal insert 1305 may convert the longitude deformation to a bending mode, of which the stiffness and thermal stress may be reduced by, e.g., at least one order of magnitude. The L-shape metal insert 1305 may have significantly less impact on an electrical contact and connected structures when there is a thermal expansion.

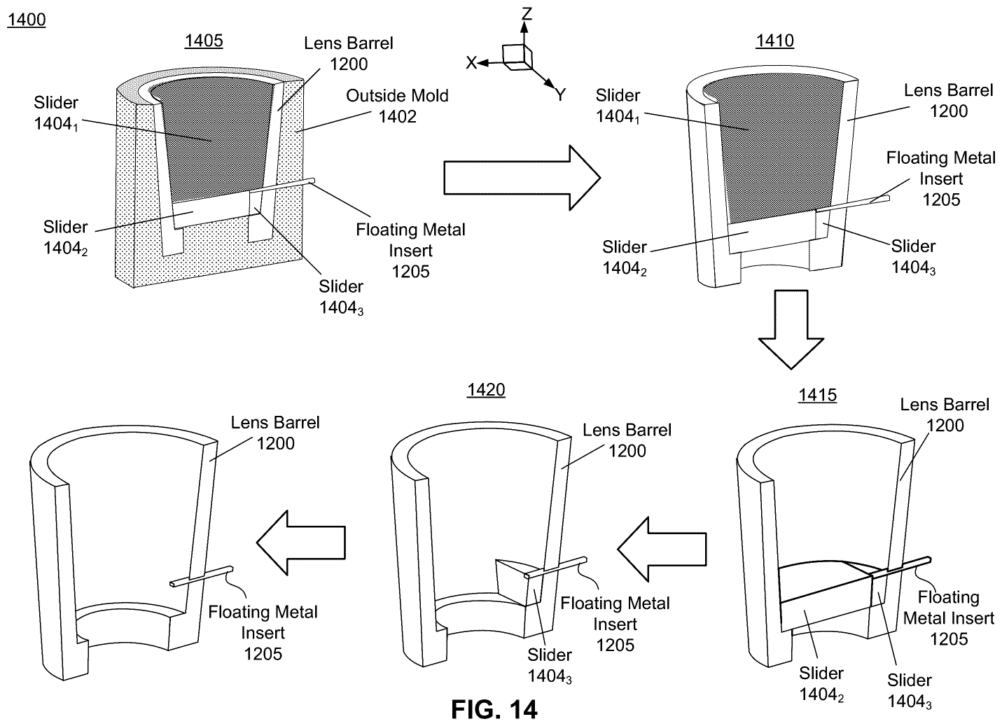

FIG. 14 illustrates an example process 1400 of forming the floating metal insert 1205 for the lens barrel 1200, in accordance with one or more embodiments. At 1405, an outside mold 1402 may be first removed from the lens barrel 1200. At 1410, a slider 14041 may be removed from the lens barrel 1200. At 1415, a slider 14042 may be removed from the lens barrel 1200. And, at 1420, a slider 14043 may be removed from the lens barrel 1200 to form the lens barrel 1200 with the floating metal insert 1205.

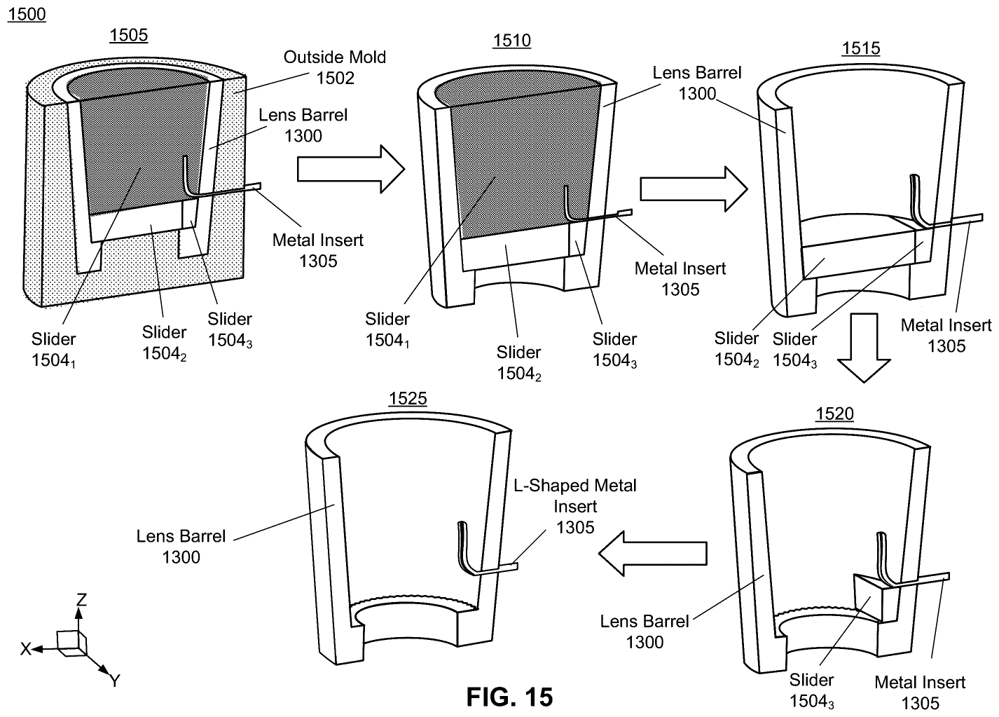

FIG. 15 illustrates an example process 1500 of forming the L-shape metal insert 1305 for the lens barrel 1300, in accordance with one or more embodiments. At 1505, an outside mold 1502 may be removed from the lens barrel 1300 and the L-shape metal insert 1305. At 1510, a slider 15041 may be removed from the lens barrel 1300. At 1515, a slider 15042 may be removed from the lens barrel 1300. At 1520, a slider 15043 may be removed to form the lens barrel 1300 with the L-shape metal insert 1305. At 1525, a metal cutting may be performed at the L-shape metal insert 1305 to obtain the L-shape metal insert 1305 of an appropriate size for the lens barrel 1300.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A camera device comprising:
an image sensor;
a lens assembly in an optical series with the image sensor; and
an optical image stabilization (OIS) assembly configured to:
initiate a first motion of at least one of the image sensor and the lens assembly along a first direction parallel to a first axis, the first motion having a first range, and
initiate a second motion of at least one of the image sensor and the lens assembly along a second direction parallel to a second axis orthogonal to the first axis, the second motion having a second range different than the first range.

2. The camera device of claim 1, wherein the first range is symmetric about the second axis, and the second range is symmetric about the first axis.

3. The camera device of claim 1, wherein the first range is symmetric about the second axis, and the second range is asymmetric about the first axis.

4. The camera device of claim 1, wherein a central axis of the image sensor substantially overlaps with an optical axis of the lens assembly after the first motion and the second motion.

5. The camera device of claim 1, wherein the OIS assembly includes a first pair of magnets each positioned around the first axis, and a second pair of magnets each positioned around the second axis.

6. The camera device of claim 5, wherein a first dimension of each magnet from the first pair along an axis parallel to the second axis is smaller than a second dimension of each magnet from the second pair along an axis parallel to the first axis.

7. The camera device of claim 5, wherein a dimension of a magnet from the second pair along the axis parallel to the first axis is different than another dimension of another magnet from the second pair along the axis parallel to the first axis.

8. The camera device of claim 1, further comprising one or more actuators configured to actuate the first motion and the second motion based on one or more signals from the OIS assembly.

9. The camera device of claim 8, wherein the first range and the second range depend on a stiffness of one or more springs coupled to the one or more actuators.

10. The camera device of claim 8, wherein the first range and the second range depend on a strength of one or more coils of the one or more actuators.

11. The camera device of claim 1, wherein the OIS assembly initiates the first motion and the second motion responsive to the camera device changing orientation from a first orientation to a second orientation.

12. The camera device of claim 11, wherein the camera device rotates around the first axis when changing orientation from the first orientation to the second orientation.

13. The camera device of claim 11, wherein an optical axis of the lens assembly is parallel to gravity when the camera assembly is at the first orientation, and the optical axis is orthogonal to gravity when the camera device is at the second orientation.

14. The camera device of claim 1, wherein the camera device is part of a smartwatch.

15. A camera device comprising:
an image sensor; and
a lens assembly in an optical series with the image sensor, wherein
the lens assembly and the image sensor allow a first motion along a first direction parallel to a first axis having a first range and a second motion along a second direction parallel to a second axis orthogonal to the first axis having a second range different than the first range.

16. The camera device of claim 15, further comprising an optical image stabilization assembly configured to initiate the first motion and the second motion.

17. The camera device of claim 15, wherein the first range is symmetric about the second axis, and the second range is symmetric about the first axis.

18. The camera device of claim 1, wherein the first range is symmetric about the second axis, and the second range is asymmetric about the first axis.

19. A method comprising:
initiating a first motion of at least one of an image sensor and a lens assembly in a camera device along a first direction parallel to a first axis, the first motion having a first range; and
initiating a second motion of at least one of the image sensor and the lens assembly along a second direction parallel to a second axis orthogonal to the first axis, the second motion having a second range different than the first range.

20. The method of claim 19, further comprising:
initiating the first motion and the second motion responsive to the camera device changing orientation from a first orientation to a second orientation including rotation of the camera device around the first axis.
